(19) United States
(12) Patent Application Publication
(10) Pub. No.: US 2026/0186822 A1
(43) Pub. Date: Jul. 2, 2026

(54) MANAGING WORKLOAD MIGRATION IN A COMPUTING SYSTEM

(71) Applicant: Intel Corporation, Santa Clara, CA (US)

(72) Inventors: Aravindan MUTHUKUMAR, TUTICORIN (IN); Satwik KARRA, Rajahmundry (IN); Jaishankar RAJENDRAN, Bangalore (IN); Preethi KIRUBA, Bangalore (IN); Prakhar VISHWAKARMA, Bengaluru (IN)

(21) Appl. No.: 19/549,052

(22) Filed: Feb. 25, 2026

(51) Int. Cl. G06F 9/455; G06F 16/901

(52) U.S. Cl. CPC G06F 9/45558; G06F 16/9024; G06F 2009/4557

(57) ABSTRACT

An apparatus includes: a memory configured to store a graph data structure comprising a plurality of nodes representing computing resources and workloads within a computing environment; and a processor configured to: instantiate, in the graph data structure in response to a migration of a workload from a first computing resource to a second computing resource, a first node representing a state of the workload at the first computing resource before the migration; associate an edge connecting the first node to a second node representing a state of the workload at the second computing resource after the migration, wherein the edge represents a performance metric associated with the migration; and process the graph data structure comprising the first node and the edge using a Graph Neural Network (GNN) to determine an action associated with the migration of the workload.

### BACKGROUND

Computing systems may execute workloads by instantiating a plurality of virtual machines on shared hardware resources. This operation generally involves a control of a hypervisor operating system. A computing system may include a scheduler that selects, for each virtual machine, a placement on a physical topology, which the physical topology (e.g. a set of hardware resources) can include non-uniform memory access nodes or dies. Under various conditions or limitations, the scheduler may trigger migration of a virtual machine to improve load balancing and resource utilization.

A computing system that supports such virtualization may include an apparatus that cooperates with traditional hypervisor operations. The computing system further provides monitoring, analysis, and outputs that assist with placement and migration decisions for virtual machines. The apparatus may receive platform topology information and performance-related telemetry from the computing system, and the apparatus may output indicators, recommendations, or control data that a management component may use to evaluate migration behavior.

### BRIEF DESCRIPTION OF FIGURES

In the drawings, like reference characters generally refer to the same parts throughout the different views. The drawings are not necessarily to scale, emphasis instead generally being placed upon illustrating the principles of the disclosure. In the following description, various aspects of the disclosure are described with reference to the following drawings, in which:

FIG. 1 illustrates a block diagram of an example computing system;

FIG. 2 shows a block diagram of an example apparatus described herein;

FIG. 3 illustrates an example diagrammatic representation of a graph topology transformation;

FIG. 4 shows an example flowchart of an operational process;

FIG. 5 shows an example flow diagram that may be executed by an apparatus as described herein;

FIG. 6 shows schematically an example of a processor and a memory to implement a graph neural network (GNN) in accordance with various aspects provided herein;

FIG. 7 shows an example of a method.

### DESCRIPTION

Aspects described herein relate generally to the field of resource management within virtualized computing environments. The techniques can specifically relate to an apparatus including a memory and a processor configured to manage the migration of workloads between computing resources. In modern high-performance cloud infrastructures, the efficient allocation of computing resources is necessary to maintain system stability and performance. A computing environment may include a plurality of physical processing units and memory units organized into a specific topology. Virtualization technologies can allow multiple workloads, such as virtual machines, to execute simultaneously on these physical resources. A hypervisor or a virtual machine monitor may be responsible for abstracting the physical constraints of the hardware and managing the execution of these workloads.

One of the functions of the hypervisor can involve the scheduling of workloads. The scheduler may migrate a workload from a first computing resource to a second computing resource to balance the load across the system. For example, if a first processor is utilized heavily, the scheduler may move a virtual machine to a second processor that is less utilized. While such migrations aim to optimize processor utilization, they may introduce performance penalties related to memory access and data locality. The physical distance between the processing unit executing the workload and the memory unit storing the data for that workload impact the execution speed significantly.

In practice, migration decisions may not always match the actual platform topology relationships and the workload's memory locality needs. The system may trigger unnecessary or incorrect migrations due to miscalculations in scheduling logic, and such migrations may reduce workload performance. For example, as described herein, there may be scenarios in which a scheduler issue causes an incorrect migration in a scaling scenario resulting in a measurable performance loss.

If a migration decision fails to account for the topology of the computing environment or the historical state of the workload, the system may experience performance degradation. A common issue resulting from suboptimal migration decisions is involves oscillation of a workload between resources, often referred to as a ping-pong effect. This oscillation consumes interconnect bandwidth and processing cycles without improving the overall state of the computing environment. Therefore, techniques described herein may be used to analyze migration events with a granular understanding of the system topology and the transitional states of the workloads.

The implementation of resource management in complex computing environments faces several technical problems. A problem involves the detection of anomalous migrations where a scheduler moves a workload to a sub-optimal resource. Relying on heuristics using static thresholds may fail to adapt to legitimate rapid changes in workloads, such as high-frequency trading applications. A heuristic-based scheduler may react to symptoms, such as high processor utilization, rather than root causes like memory locality. This often leads to the ping-pong effect, where a workload oscillates between nodes, degrading system performance.

Another problem exists in the use of traditional machine learning models, which often ingest flat vectors of system metrics, such as processor load and memory usage, without considering the topological structure of the hardware. These models lack topological awareness and do not account for the specific bandwidth constraints or distances between different nodes. They treat metrics as independent features, thereby losing the causal structure inherent in the hardware architecture. Furthermore, prior attempts to use graph models typically update the graph by simply deleting the workload from the source node and adding it to the destination node. This approach deletes the historical context of the migration. The model loses the critical information regarding where the workload originated, which is a primary predictor of a potential ping-pong event.

Techniques involving apparatus and methods described herein may be implemented within a computing environment. These techniques can employ a dynamic graph topology modification. In an example, a processor may instantiate a first node, referred to as a virtual node, in the graph data structure in response to a migration. This first node represents the state of the workload at the first computing resource before the migration. By retaining this historical state within the graph topology, the apparatus preserves the context that is lost in standard graph updates. The processor further associates an edge, referred to as a virtual edge, connecting this first node to a second node representing the workload at the new location. This edge represents a performance metric, or edge strength, associated with the migration.

This structural modification can transform the temporal problem of analyzing migration history into a spatial problem of graph connectivity. A graph neural network can process the graph data structure including the first node and the edge to determine an action. The graph neural network can aggregate feature parameters from the first node propagated via the virtual edge to update the embedding of the second node. This captures the residual dependency of the workload on the first computing resource. The processor may monitor the performance metric represented by the edge over a predetermined number of time epochs. If the metric does not decay, indicating that the workload is not decoupled from the source, the processor classifies the migration as anomalous.

In some examples, to address the problem of selecting a better destination after an anomaly is detected, the processor may trigger a link prediction model. Instead of simply reverting the workload to the source, which may also be overloaded, the link prediction model calculates probability scores for connections to other available computing resources. This allows the system to identify a third computing resource that is mathematically optimal based on the learned embeddings, thereby breaking the cycle of oscillation between the first and second resources. The apparatus thereby ensures that migration decisions are based on a comprehensive understanding of both the physical topology and the dynamic transition states of the workloads.

In various cases, the computing environment may be characterized by a non-uniform memory access (NUMA) architecture. In a symmetric multi-processing model, multiple processor cores may share a single bus to access memory, which may become a bottleneck as core counts increase. The non-uniform memory access architecture addresses this limitation by compartmentalizing memory and processing power into discrete units referred to as nodes. A non-uniform memory access node may include a set of execution cores and a designated range of physical memory that those cores can access with the lowest latency. Accessing memory attached to the same node is referred to as local access, while accessing memory on a different node is referred to as remote access. Remote access requires traversing an interconnect, which increases latency and reduces throughput.

The physical topology of the computing environment may include physical sockets and logical nodes. A physical socket in this context refers to the physical processor package installed on the motherboard. Modern processors may employ internal partitioning techniques, such as sub-NUMA clustering, where a single physical socket is partitioned into multiple logical non-uniform memory access nodes. Consequently, a migration of a workload may occur within a socket or between sockets, with differing costs associated with each move. The systems operating within this architecture are typically cache-coherent. The system may implement various hardware mechanisms to ensure that if a core in one node modifies data, a core in another node does not read a stale value. These mechanisms involve cache transactions that consume interconnect bandwidth.

The term “node” described herein may refer to a transient vertex in a graph data structure, noting its distinction from a non-uniform memory access node described above. A processor, as described herein, can instantiate such a node in the graph data structure subsequent to the initiation or execution of a migration event. This node may be considered as a “virtual node” as it does not actually represent an actual physical state. This instantiated node can serve as a historical placeholder or a shadow representing the state and location of the workload at the first computing resource, or source node, immediately prior to the migration. Such a virtual node is not a representation of a new physical resource or a new active virtual machine instance.

Functionally, the node may store a frozen state vector of the workload, including feature parameters such as memory footprint and cache usage, captured at the time of migration. This may allow the graph neural network to compare the historical performance at the source against the current performance at the destination.

The term “edge” described herein may refer to a connection between at least two nodes. A processor, as described herein, may set an edge as a directed connection established in the graph data structure between a second node (e.g., a node representing an actual workload, such as the workload at the second computing resource (after the migration), and the first node (before the migration), which is the virtual node. In this constellation involving the virtual node, the edge may be referred to as a “virtual edge”. This virtual edge may explicitly model the residual dependency or friction between the current state of the workload and its previous state. Structurally, it is an edge in the adjacency matrix of the graph. Functionally, the virtual edge can facilitate the propagation of information during the message-passing phase of the graph neural network, allowing the embedding of the migrated workload to include information regarding its previous location.

A processor, as described herein, may associate weights (e.g. scalar weights) to edges in the graph data structure. An associated weight may quantify the degree of dependency between the two nodes of the edge. This associated weight may also be referred to as an edge strength. In the example of a virtual edge described above, its weight may represent a metric associated with the migration. For example, the metric may be the degree of dependency between the migrated workload and the first computing resource. The processor may calculate the weight based on hardware telemetry data, which may, for example, include the rate of remote memory page accesses and cache transactions across the interconnect. A high weight value indicates a high dependency, suggesting that the workload is still heavily relying on resources located at the first computing resource. The processor can monitor this metric over time to determine if the workload is successfully settling into the new location.

The term “graph neural network” refers to a neural network architecture that operates on graph-structured data. The graph neural network processes the plurality of nodes and edges to generate latent embeddings for each node. It utilizes a message-passing mechanism where a node updates its representation by aggregating features from its neighbors. In various aspects described herein, the graph neural network may include an encoder layer to transform raw features and a classification layer to output a probability distribution regarding the status of the migration.

The term “migration anomaly” or “anomalous migration” described herein may refer to a state where a migration event results in suboptimal system performance or stability. The degree of it being suboptimal may be based on a predefined performance metrics. In some cases, the suboptimal system performance or stability may necessitate a corrective action such as a reversal of the migration. A processor, as described herein, may base this determination on the analysis of the performance metric represented by the virtual edge (i.e. the edge involving the virtual node and the node representation of the actual migrated workload). For example, if the edge weight remains high and does not decay over a predetermined number of epochs, the processor classifies the migration as an anomaly. This state can indicate that the expected performance benefits of the migration were not realized due to factors like memory latency or cache contention.

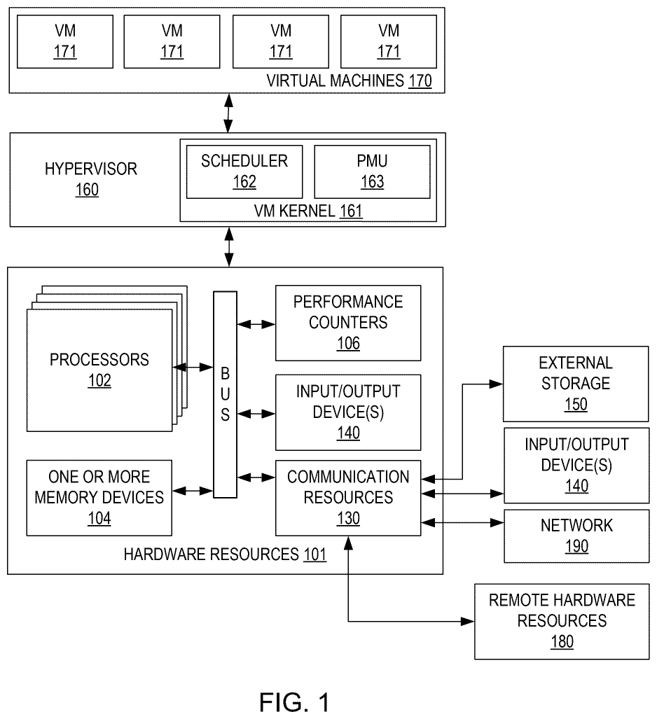

FIG. 1 illustrates a block diagram of an example computing system in accordance with various aspects described herein. The computing system 100 (a computing environment) typically includes a system of interconnected hardware and software resources configured to execute instructions, process data, and manage the allocation of computational capabilities. The computing system 100 may be a server, a workstation, a cluster of servers, a data center, or a cloud computing infrastructure. The computing system 100 includes hardware resources 101, which provide the physical resources for data processing. Hardware resources 101 form a base layer. The hypervisor 160 sits above the hardware resources 101 and interfaces with the processors, memory devices, performance counters, and other hardware resources over the bus and the communication resources. The virtual machines 170 sit above the hypervisor and rely on the hypervisor for access to hardware resources. External storage 150, network 190, external input and output devices 140, and remote hardware resources 180 connect to the hardware resources via the communication resources 130 and input and output devices 140.

The hardware resources 101 may be configured to operate according to a specific architecture, such as a non-uniform memory access architecture, where the physical location of memory relative to a processor affects performance. The hardware resources 101 generally include one or more processors 102, one or more memory devices 104, performance counters 106, a bus, communication resources 130, and one or more input/output devices 140. These components can interact to support the execution of software layers, including a hypervisor 160, virtual machines 170, and/or techniques described herein associated with migration.

The processors 102 represent the computational core of the hardware resources 101. The processors 102 may include one or more physical processing units. Each processing unit among the processors 102 may constitute a central processing unit, a microprocessor, a digital signal processor, or a graphics processing unit configured to perform general-purpose computing tasks. The processors 102 may include, for example, one or a combination of: a central processing unit (CPU), a reduced instruction set computing (RISC) processor, a complex instruction set computing (CISC) processor, a graphics processing unit (GPU), a DSP, an ASIC, an FPGA, a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof.

In an example, the processors 102 may include a plurality of processor sockets located on a mainboard of the computing system 100. A processor socket serves as a physical connector and interface for a single physical processor package. Each physical processor package installed in the processors 102 may contain a single execution core or a plurality of execution cores. When the processors 102 include multi-core processors, each core may independently execute instructions, thereby enabling parallel processing. The processors 102 may support simultaneous multithreading technology, allowing a single physical core to function as multiple logical processors by maintaining separate architectural states for multiple threads of execution. This capability allows the hardware resources 101 to manage a high density of concurrent workloads.

The processors 102 may be configured to operate with internal architectures that partition resources into clusters. For instance, a single processor package within the processors 102 may be logically divided into sub-clusters, where each sub-cluster functions as a distinct non-uniform memory access node. This internal partitioning, such as sub-non-uniform memory access clustering, creates a hierarchy of access latencies even within a single physical socket. The processors 102 may include internal registers, control units, and arithmetic logic units to fetch, decode, and execute instructions defined by an instruction set architecture. The instruction set architecture may be a complex instruction set computing architecture or a reduced instruction set computing architecture. The processors 102 may further include a cache memory hierarchy. The cache memory hierarchy typically includes a level one cache dedicated to each core, a level two cache which may be dedicated or shared, and a level three cache or last-level cache that is typically shared among all cores within a processor or a cluster. The cache memory hierarchy can store frequently accessed data and instructions to reduce the latency associated with accessing the one or more memory devices 104.

In some examples, the one or more processors 102 may execute instructions (e.g. non-transitory computer-readable instructions). Instructions may include software, program code, application(s), applet(s), an app(s), firmware, microcode, machine code, and/or other executable code for causing at least any one of the processors 102 to perform a method, (e.g. any one or more of the methodologies and/or techniques discussed herein). The instructions may reside, completely or partially, within at least one of the processors 102 (e.g., within the processor's cache memory), the memory devices 104, or any suitable combination thereof. Furthermore, any portion of the instructions may be transferred to the computing system 100 from any combination of the input and/or output devices 140 or the external storage 150.

The one or more memory devices 104 provide the main storage for data and instructions that are actively used by the processors 102. The one or more memory devices 104 may include volatile memory technologies, such as dynamic random access memory, synchronous dynamic random access memory, or static random access memory. In high-performance configurations, the one or more memory devices 104 may include high bandwidth memory or double data rate synchronous dynamic random access memory. The one or more memory devices 104 can be organized into physical banks or modules, such as dual in-line memory modules. Within the context of the hardware resources 101, the one or more memory devices 104 may be distributed across different memory controllers associated with specific processors or specific non-uniform memory access nodes.

As examples, the memory devices 104 can be or can include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies (e.g., single-level cell (SLC), multi-level cell (MLC), quad-level cell (QLC), tri-level cell (TLC), or some other NAND), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level phase change memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge random access memory (CB-RAM), or spin transfer torque (STT)-MRAM, a spintronic magnetic junction memory based device, a magnetic tunneling junction (MTJ) based device, a domain wall (DW) and spin orbit transfer (SOT) based device, a thyristor based memory device, and/or a combination of any of the aforementioned memory devices, and/or other memory.

The distribution described herein associated with the memory devices 104 can establish the non-uniform memory access topology. A specific range of physical addresses within the one or more memory devices 104 is assigned to a specific physical node, creating a domain of local memory for the processors 102 associated with that physical node. Access to this local memory can provide a desired latency/bandwidth trade-off. Conversely, memory ranges assigned to other nodes are considered remote memory. The one or more memory devices 104 may be cache-coherent, ensuring that data modifications performed by one core are visible to other cores across the system. This coherency may be maintained by hardware protocols, such as a cache coherency protocol, which manages the states of cache lines and coordinates data exchange between the processors 102 and the one or more memory devices 104. The capacity of the one or more memory devices 104 determines the volume of workloads that can reside in the memory simultaneously without necessitating paging to external storage.

The processors 102 and the one or more memory devices 104 communicate via a bus or an interconnect system. The bus represented in FIG. 1 generally illustrates the data pathways within the hardware resources 101. In practice, this bus may include a complex web of point-to-point interconnects, such as the ultra path interconnect or the quickpath interconnect. These interconnects facilitate high-speed data transfer between different processor sockets and between processors and memory controllers. The interconnects possess finite bandwidth and impose latency penalties on data traversing them. When a processor core attempts to access a memory address located in a remote portion of the one or more memory devices 104, the request traverses this interconnect, resulting in remote access latency.

The hardware resources 101 further include performance counters 106. The performance counters 106 may be specialized hardware registers embedded within the processors 102 or within platform circuitry. The performance counters 106 may be configured to track and count designated hardware events that occur during the execution of instructions. These events may include, but are not limited to, the number of instructions retired, the number of central processing unit cycles elapsed, the number of cache hits and misses at various levels of the cache hierarchy, the number of branch mispredictions, and the number of memory access transactions. Specifically, the performance counters 106 may be configured to distinguish between local memory accesses and remote memory accesses.

The performance counters 106 may also track interconnect traffic, such as data packets or snoop requests sent between sockets. The data accumulated by the performance counters 106 can serve as a source of telemetry for analyzing the behavior of the hardware resources 101. This data is accessible to software layers, such as the hypervisor 160 or an operating system, often through a performance monitoring unit interface. Access to the performance counters 106 may enable the precise quantification of resource utilization and the identification of bottlenecks, such as memory bandwidth saturation or excessive cross-node traffic. The performance counters 106 may be programmable, allowing software to select specifically which events to monitor from a predefined set of architectural performance events.

The communication resources 130 enable the hardware resources 101 to exchange data with external entities. The communication resources 130 may include one or more network interface controllers, host bus adapters, or input/output fabric interfaces. The network interface controllers may support various communication standards, such as Ethernet, InfiniBand, or Fibre Channel. The communication resources 130 manage the physical and data link layers of the communication protocols, handling the transmission and reception of data packets. In a virtualized environment, the communication resources 130 may utilize technologies such as single root input/output virtualization to allow multiple virtual machines to share a single physical network interface device directly. The communication resources 130 connect the hardware resources 101 to a network 190. The network 190 may be a local area network, a wide area network, the internet, or a dedicated storage area network. Through the network 190, the computing system 100 may access remote hardware resources 180 and external storage 150. For example, the communication resources 130 may include wired communication components, cellular communication components, Wi-Fi components, and other communication components.

The input/output devices 140 associated with the hardware resources 101 represent local peripheral interfaces and devices. These may include storage controllers, such as redundant array of independent disks controllers, universal serial bus controllers, and interfaces for human interaction devices like keyboards and monitors if the system is configured for direct user interaction. The input/output devices 140 may also include hardware accelerators, such as field-programmable gate arrays or application-specific integrated circuits, installed to offload specific processing tasks from the processors 102. The bus facilitates the communication between the processors 102 and the input/output devices 140, often utilizing standards like peripheral component interconnect express. FIG. 1 also illustrates input/output devices 140 external to the hardware resources 101, which may represent peripherals connected via the communication resources 130 or the network 190, providing flexibility in system configuration.

In some examples, the input and/or output devices 140 may include one or more sensors. The sensors include devices, modules, or subsystems whose purpose are to detect events or changes in its environment and send the information (sensor data) about the detected events to some other a device, module, subsystem, and/or the like. Individual sensors may be exteroceptive sensors (e.g., sensors that capture and/or measure environmental phenomena and/or external states), proprioceptive sensors (e.g., sensors that capture and/or measure internal states of a compute node or platform and/or individual components of a compute node or platform), and/or exproprioceptive sensors (e.g., sensors that capture, measure, or correlate internal states and external states).

The external storage 150 represents persistent data storage repositories located outside the immediate physical chassis of the hardware resources 101. The external storage 150 may include storage area networks, network-attached storage systems, or cloud-based storage services. The external storage 150 may store virtual machine images, application data, and operating system files that are loaded into the one or more memory devices 104 during operation. The connection to the external storage 150 allows for centralized data management and facilitates features such as high availability, where a workload can be restarted on different hardware resources if the primary hardware fails. Access to the external storage 150 is mediated by the communication resources 130 and the protocols of the network 190, such as internet small computer systems interface or non-volatile memory express over fabrics.

The remote hardware resources 180 generally represent other computing nodes or clusters available via the network 190. In a distributed computing system 100, the hardware resources 101 may function as one physical node in a larger cluster, with the remote hardware resources 180 constituting the other physical nodes. The remote hardware resources 180 may possess similar or different configurations compared to the hardware resources 101. The ability to communicate with the remote hardware resources 180 enables distributed processing, where a single large task is decomposed into smaller sub-tasks executed in parallel across multiple machines. It also enables the migration of workloads not just within the non-uniform memory access nodes of the hardware resources 101, but also between entirely different physical servers represented by the hardware resources 101 and the remote hardware resources 180.

The hypervisor 160, also referred to as a virtual machine monitor, includes a software layer that executes on the hardware resources 101. The hypervisor 160 may be configured for creating, running, and managing the virtual machines 170. The hypervisor 160 may abstract the physical details of the processors 102, the one or more memory devices 104, and other hardware components, presenting them as virtualized resources to the virtual machines 170. The hypervisor 160 may be a hypervisor that runs directly on the bare metal hardware, such as VMware ESXi, or one that runs as an application within a host operating system, such as Linux KVM, a kernel-based hypervisor. The hypervisor 160 may have direct control over the hardware or through execution of a processor (e.g. the processors 102).

The hypervisor 160 can include a virtual machine kernel 161. The virtual machine kernel 161 acts as the operating system for the virtualization platform. The virtual machine kernel 161 may manage memory allocation, processor scheduling, and input/output request processing. The virtual machine kernel 161 may operate at the highest privilege level, often referred to as ring zero or root mode, ensuring it has full control over the system resources. Within the virtual machine kernel 161, a scheduler 162 may be provided. The scheduler 162 may be configured for determining which physical processor core runs which virtual central processing unit at any given time. The scheduler 162 implements logic to balance the computational load across the available processors 102. The scheduler 162 monitors the utilization of the physical cores and the demands of the virtual machines 170.

Based on this monitoring, the scheduler 162 can make decisions to migrate virtual machines or specific virtual central processing units from one core or node to another. In an example, the scheduler 162 attempts to maintain non-uniform memory access affinity, where a virtual machine's processing threads are co-located on the same node as its memory pages. However, the scheduler 162 must also respond to contention for processor cycles. If a particular physical node becomes overloaded, the scheduler 162 may decide to move a workload to a less utilized physical node to maintain fairness and responsiveness. The scheduler 162 manages the context switching required to share physical cores among multiple virtual machines, saving the state of a paused virtual machine and restoring the state of the next virtual machine to be executed.

The virtual machine kernel 161 can further include a performance monitoring unit 163. This software performance monitoring unit 163 interfaces with the physical performance counters 106. The performance monitoring unit 163 provides a mechanism for the hypervisor 160 to read and interpret the raw event counts generated by the hardware. It may also virtualize the performance counters 106, allowing the virtual machines 170 to access a subset of performance data relevant to their own execution. The performance monitoring unit 163 collects telemetry data including instructions per cycle, cache miss rates, and memory bandwidth usage. This data is utilized by the scheduler 162 and potentially by other management tools to assess the health and efficiency of the system. The performance monitoring unit 163 may sample the performance counters 106 at defined intervals, creating a time-series of system performance metrics.

The virtual machines 170 represent the workloads executing on the computing system 100. Each virtual machine 171 may be an isolated software container that behaves like a complete physical computer. A virtual machine 171 includes a guest operating system and one or more applications. The guest operating system may be any standard operating system, such as Windows or Linux, which manages the resources allocated to the virtual machine 171 by the hypervisor 160. Each virtual machine 171 is assigned a set of virtual hardware resources, including virtual central processing units, virtual random access memory, and virtual network adapters. The virtual central processing units may be time-sliced representations of the physical processors 102. The virtual random access memory may be mapped to physical pages within the one or more memory devices 104.

The virtual machines 170 execute their instructions on the processors 102 under the supervision of the hypervisor 160. When a virtual machine 171 performs a privileged operation or accesses a hardware resource, the control may trap to the hypervisor 160, which emulates the operation or mediates the access. The isolation provided by the virtual machines 170 ensures that a failure or security breach in one virtual machine 171 does not compromise the host system or other virtual machines 170. The virtual machines 170 are mobile entities within the virtualized environment. The hypervisor 160 can perform a live migration of a virtual machine 171, moving its execution state and memory contents from one physical location to another while the virtual machine 171 continues to run.

The interaction between the scheduler 162 and the virtual machines 170 may be continuous. As the computational demand of a virtual machine 171 fluctuates, the scheduler 162 can dynamically adjust the allocation of processor cycles. If a virtual machine 171 is idle, the scheduler 162 may yield its allocated time to other active workloads. When a virtual machine 171 becomes active, the scheduler 162 may identify an appropriate physical node for its execution. This placement decision may be influenced by the topology of the hardware resources 101. For example, placing a virtual machine 171 on a core that has access to the virtual machine's data in a local cache or local memory node may be preferred over a placement that requires remote access.

In a non-uniform memory access configuration, the latency experienced by a virtual machine 171 can vary based on the placement of its memory pages relative to its execution threads. The hypervisor 160 may obtain physical topology information from firmware tables and operating system interfaces, to understand the physical layout of the hardware. These tables inform the hypervisor 160 for placement decisions (e.g. about which ranges of the one or more memory devices 104 belong to which non-uniform memory access node and the distance or cost associated with accessing them). When the scheduler 162 migrates a virtual machine 171, the memory pages associated with that virtual machine 171 do not necessarily move instantly. They may remain on the source node, creating a situation where the virtual machine 171 is executing on a destination node while accessing memory remotely.

The input/output operations of the virtual machines 170 can be routed through the communication resources 130 and the input/output devices 140. The hypervisor 160 may employ virtual switches to manage network traffic between virtual machines 170 on the same host and between virtual machines 170 and the external network 190. These virtual switches route packets based on media access control addresses or internet protocol addresses. The performance of these input/output operations may also be subject to non-uniform memory access effects. If a peripheral device is attached to a specific bus or root complex associated with a specific non-uniform memory access node, accessing that device from a processor core on a different node incurs additional latency. The hypervisor 160 attempts to account for these input/output locality constraints when making scheduling decisions.

The computing system 100 depicted in FIG. 1 is designed to support scalable and flexible resource utilization. However, the complexity of the hardware resources 101, particularly the non-uniform memory access characteristics and the shared nature of the interconnects, can create challenges for the scheduler 162. Simple heuristics based solely on processor utilization may fail to capture the nuances of memory locality and interconnect saturation. For instance, a decision to migrate a virtual machine 171 to balance processor load might result in severe memory latency penalties if the data does not follow the computation efficiently. This disconnect between the logical view of resources held by the scheduler 162 and the physical reality of the hardware resources 101 necessitates advanced monitoring and analysis capabilities, which rely on the detailed telemetry provided by the performance counters 106 and the performance monitoring unit 163.

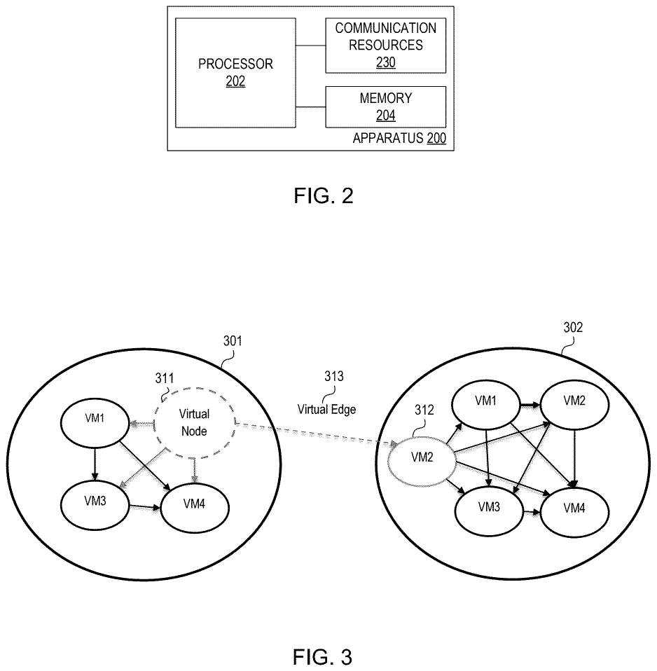

FIG. 2 shows a block diagram of an example apparatus described herein. The apparatus 300 may be configured to implement techniques for optimized virtual machine migration analysis described herein. The apparatus 200 described herein can include structural and logical components for executing the logic required to implement techniques associated with workload migration (e.g. detect and mitigate anomalous migrations) within a computing environment, such as the computing system described with reference to FIG. 1. The apparatus 200 may act as a controller, a dedicated monitoring node, or a logical entity integrated within a hypervisor (e.g. the hypervisor 160) or a virtual machine kernel (e.g. the virtual machine kernel 161) of hardware resources (e.g. the hardware resources 101).

The apparatus 200 includes a processor 202, a memory 204. The apparatus 200 may further include and communication resources 230. In an example, these may be part of hardware resources of the computing system (e.g. the one or more processors 102, the one or more memory devices 104, the communication resources 130). These components may be operationally coupled to facilitate the exchange of data to ensure that the apparatus 200 can react to system events, such as virtual machine migrations, in near real-time.

In an example, the logical components of the apparatus 200 may be organized into a front-end unit and an artificial intelligence (AI) unit. The front-end may function as a primary interface configured to receive platform and operating system parameters, such as those provided by the virtual machine kernel. Upon a system initialization or boot sequence, the AI model gathers this topology information from the front-end component to construct the initial graph data structure and perform AI operations on the graph data structure as described herein.

The processor 202 serves as the computational core of the apparatus 200. The processor 202 can be coupled to the communication resources 230 and the memory 204. The processor 202 may be implemented as a portion of the processors 102 described in FIG. 1, or it may constitute a distinct, dedicated processing unit configured to implement aspects described herein, such as being configured for telemetry analysis and artificial intelligence model inference. The processor 202 may include one or more processing cores, microcontrollers, or specialized accelerators, such as neural network processing units, designed for efficient matrix operations.

The processor 202 may execute instructions to perform the monitoring and analysis functions described herein. Initially, the processor 202 interacts with the hardware platform to discover the system topology (e.g. hardware topology). The processor 202 may read system configuration tables, such as at least one of the advanced configuration and power interface (ACPI), system resource affinity table (SRAT) and the system locality information table (SLIT).

Based on this information, the processor 202 may identify the hierarchy of computing resources, including physical sockets, non-uniform memory access nodes, processor dies, and interconnect links. The processor 202 may determine the physical layout of the non-uniform memory access nodes, sockets, and interconnects accordingly. The processor 202 may utilize this topological data to initialize and maintain the graph data structure stored in the memory 204

Using this topological data, the processor 202 initializes a graph data structure stored in the memory 204. A graph data structure may include information representing at least one graph. A graph, as described herein, includes a collection of objects (i.e. nodes, vertices) and information associated with a set of interactions (edges) between pairs of these objects. A graph G=(V,E) can be defined by a set of nodes (vertices), V, and a set of edges E between the nodes. In other words, a graph may be defined with a first set of data items including information of each node, and a second set of data items including information representing how nodes are related.

In order to represent a graph with data items, an adjacency matrix A may be used to indicate or represent the presence of edges between the nodes in a manner that every node indexes a particular row and column in the adjacency matrix. In such example, a value of the adjacency matrix A associated with nodes (u,v), where u and v denote a first node and a second node, may be denoted with 1 if an edge is present between the first node u and the second node v, or the value of the adjacency matrix A associated with nodes (u,v) becomes 0 if an edge is not present between the nodes. In various aspects, an adjacency matrix may include a weighted adjacency matrix to represent weighted edges of the graph. A weighted edge may represent a relation between nodes that is not binary. A weighted adjacency matrix may include, or may be denoted with, an adjacency matrix representing the presence of edges between nodes and a weight matrix representing the degree of the relation or interaction (i.e. strength of association) between the nodes.

The processor 202 may map the hardware topology to a plurality of nodes within the graph data structure. These nodes represent the distinct entities within the computing system. A first subset of these nodes represents computing resources. For example, a first set of nodes in the graph represents the physical computing resources (e.g., NUMA nodes). Additionally, or alternatively, the first set of nodes may represent processor sockets, distinct processor dies, or individual cores. Edges between these resource nodes represent the physical interconnects. In some examples, the edges may be weighted by bandwidth and latency attributes. As workloads, such as virtual machines, are instantiated, the processor 202 may add a second set of nodes to the graph representing these workloads, connecting them to the resource nodes where they are currently resident. These workload nodes may correspond to virtual machines, containers, or specific processes that consume the computing resources. This graph data structure may represent the computing system's state, modeled as a network of entities and relationships.

Furthermore, the processor 202 may be configured to perform continuous or periodic monitoring of the computing system. This monitoring may involve the sampling of performance counters and the interception of event signals generated by a hypervisor scheduler. When the processor 202 detects a trigger event, for example, the migration of a workload, the processor 202 may execute logic to modify the graph data structure in the memory 204 dynamically. This modification can involve the structural instantiation of new graph elements that represent the transitional physics of the migration. Following the modification, the processor 202 may employ a graph neural network logic to process the updated graph, performing mathematical operations such as matrix multiplications and non-linear activations to derive actionable insights regarding the validity of the migration.

The memory 204 may store data and instructions accessible by the processor 202. The memory 204 may include a hierarchy of storage technologies, including volatile random access memory for active data structures and non-volatile storage for persistent model weights and historical logs. The memory 204 may store the graph data structure.

The processor 202 and the memory 204 maintains this graph data structure dynamically. As the state of the computing environment changes—for example, as new virtual machines are instantiated or as resource usage fluctuates—the processor 202 updates the graph data structure in the memory 204. The graph data structure may be implemented in the memory 204 using various formats, such as adjacency matrices, adjacency lists, or edge lists, suitable for processing by graph neural network algorithms.

The processor 202 may instantiate a first node (virtual node) in the graph data structure stored in the memory 204. The processor 202 may be configured to perform this instantiation in response to a migration of a workload from a first computing resource to a second computing resource. The migration refers to the process of moving the execution state of the workload from a source physical node (e.g., a source non-uniform memory access node) to a destination physical node (e.g., a destination non-uniform memory access node). The first node represents a state of the workload at the first computing resource before the migration. The processor 202 may generate this first node to act as a historical placeholder or a shadow vertex within the graph in response to a received indication of the migration. This first node is distinct from the node representing the workload at the second computing resource. The processor 202 may create the first node to preserve the context of the migration, which would otherwise be lost if the graph were updated merely by moving the existing workload node.

To instantiate the first node, the processor 202 may allocate memory for a new vertex in the graph data structure. The first node represents a state of the workload at the first computing resource before the migration. This first node is distinct from the node representing the workload at its new location. The processor 202 may populate this new vertex with a feature vector derived from the workload. The processor 202 may capture this feature vector at a specific time, such as the moment immediately preceding the migration or during the migration process. The feature vector assigned to the first node includes feature parameters that are identical to the feature parameters associated with the workload while it was resident at the first computing resource. These feature parameters may include telemetry data, such as at least one or a combination of the total processing cycles allotted to the workload, the processing cycles utilized by the workload, and the number of memory pages allotted to the workload. By keeping these parameters in the first node, the processor 202 can enable a differential analysis between the past performance of the workload and its current performance.

This first node serves as a “shadow” or a historical anchor. By creating this node, the apparatus 200 provides a history of the migrated workload by retaining a representation of “where the workload came from” and “how it was performing”. This can allow the computing system to perform a differential analysis, comparing the current performance at the second computing resource against the historical performance captured in the first node. The processor 202 may use this comparison for determining whether the migration has yielded the intended performance benefits or if it has resulted in degradation.

The processor 202 may further instantiate and maintain the second node (i.e. destination node) in a manner that it represents the state of the workload at the second computing resource after the migration. This second node is the actual (active) representation of node of the workload in its current execution context.

The processor 202 may further associate an edge (a virtual edge) connecting the first node to a second node. This edge is a directed connection that links the first node (i.e. historical representation of the workload) to the second node (i.e. its current active representation). This edge represents a performance metric associated with the migration. The processor 202 can utilize this edge to model the residual dependency or friction between the workload's new computing resource and its previous computing resource. The edge may serve as a virtual connection that quantifies the cost of the transition state (i.e. the migration). The processor 202 may assign a weight or a set of features to this edge that quantifies the relationship between the old state and the new state.

To associate this edge, the processor 202 may calculate a specific value or weight for the edge based on hardware telemetry. The processor 202 monitors data received via the communication resources 230 to determine this performance metric. The performance metric may be a composite scalar value derived from multiple hardware events. For example, the processor 202 may calculate the performance metric based on a page migration rate. The page migration rate indicates the number of memory pages associated with the workload that are being transferred from the first computing resource to the second computing resource. A high page migration rate (corresponding to a strong edge) can suggest that the workload is still heavily reliant on memory residing at the source node. In an example, the performance metric may be a composite value derived from multiple factors. The performance metric, and corresponding edge, effectively models the cost of the transition state.

Additionally, or alternatively, the processor 202 may calculate the performance metric based on the number of cache transactions occurring between the first computing resource and the second computing resource. These cache transactions may include snoop requests or data transfers triggered by cache coherency protocols. The processor 202 may monitor the performance monitoring unit for specific events, such as hit modified events, associated with the process identifier of the workload. A high volume of cross-node cache traffic increases the value of the performance metric, indicating a strong residual coupling between the workload and its previous host. The processor 202 updates the weight of this edge continuously or at defined sampling intervals to reflect the real-time state of the migration.

The processor 202 may be further configured to process the graph data structure including the first node (virtual node) and the edge (virtual edge) using a graph neural network. The graph neural network is a machine learning model designed to operate on graph-structured data. The processor 202 can execute the graph neural network to determine an action associated with the migration of the workload. The processing may involve a message-passing mechanism where nodes within the graph update their internal representations by aggregating information from connected neighbors. In an example, once the graph data structure has been modified to include the first node (virtual node) and the edge (virtual edge), the processor 202 processes this structure using the graph neural network.

In an example of the graph neural network, the processor 202 may utilize a graph convolution network (GCN) classifier including a GCN encoder and a classification layer. The GCN encoder may be configured with a two-layer architecture designed to extract features from the raw metrics of the virtual machines. The first layer of this architecture transforms the raw feature vectors into hidden representations utilizing a rectified linear unit (ReLU) activation function to introduce non-linearity. The second layer subsequently may refine these hidden representations into the final latent embeddings. This multi-layer approach can allow the model to effectively capture the complex interactions between the workloads while preserving the topological relationships defined by the graph structure.

During the processing of the graph data structure, the graph neural network may be configured to allow the second node (the current workload) to aggregate information from the first node (virtual node) via the connecting edge. The weight of the edge (the performance metric) influences how much of the state at the first node is propagated to the current state representation. For example, the processor 202 updates a latent embedding of the second node. An embedding is a vector representation that captures both the intrinsic features of a node and the structural information from its neighborhood. The processor 202 aggregates feature parameters from the first node propagated via the edge representing the performance metric. This propagation can allow the embedding of the second node to include information regarding the workload's previous state and the cost of the migration. The weight of the edge modulates the influence of the first node on the second node. If the performance metric indicates a high degree of friction, the message passed from the first node significantly impacts the embedding of the second node, effectively signaling that the workload is not yet settled.

The processor 202 can utilize the output of the graph neural network to classify the migration. The processor 202 may determine the action by classifying the migration as anomalous based on one or more values of the performance metric. An anomalous migration may represent a state where the migration fails to yield expected (e.g. predefined) performance benefits or causes system instability. To make this determination, the processor 202 may monitor the performance metric over a predetermined number of time epochs. For example, the processor 202 checks if the performance metric decreases over time. In a successful migration, the dependency on the source node typically decays as memory pages are moved and caches perform warm-up.

The processor 202 may classify the migration as anomalous if the performance metric fails to decay below a threshold within the predetermined number of time epochs. For example, if the edge strength remains high for a period of two to three epochs, the processor 202 identifies the migration as an anomaly. In some examples, the processor 202 may be configured to dynamically adjust this threshold based on a system context of the computing system. The system context may include global platform parameters such as total traffic load or hardware capabilities. If the hardware supports high bandwidth memory, the processor 202 may increase the threshold, tolerating a higher rate of remote access before flagging an anomaly. Conversely, if the system traffic is low, the processor 202 may decrease the threshold to enforce stricter locality requirements.

The processor 202 may determine an action that may include generating a control signal. This control signal may include an indication of a migration anomaly. The processor 202 transmits this signal via the communication resources 230 to a hypervisor scheduler. The control signal may instruct the scheduler to reverse the migration or to prevent further migrations for a specific duration.

Furthermore, the action may include triggering a link prediction model of the graph neural network. The processor 202 may execute this model in response to classifying the migration as anomalous. The link prediction model may be configured to identify a third computing resource for a further migration of the workload. Instead of simply reverting to the first computing resource, which may be congested, the processor 202 may facilitate a seeking of an optimal alternative placement.

In an example, the processor 202 identifies the third computing resource by calculating a probability score. This score may represent a likelihood of a positive connection between the second node representing the workload and a third node representing the third computing resource. The processor 202 may compute this score using the latent embeddings generated by the graph neural network. A high probability score indicates that the third computing resource possesses the capacity and connectivity required to host the workload efficiently. The processor 202 may transmit a control signal to the hypervisor scheduler to initiate the further migration of the workload to the third computing resource based on the identified third computing resource. The processor 202 may further be configured to train the graph neural network by

adjusting model parameters stored in the memory 204. The processor 202 may execute a training routine that utilizes a loss function. This loss function may be designed to maximize the probabilities assigned to existing positive edges in the graph data structure. Simultaneously, the loss function minimizes the probabilities assigned to non-existent negative edges. The processor 202 may use a log loss calculation to penalize incorrect predictions, refining the model's ability to distinguish between valid and anomalous connections. This training may occur offline or online as the system accumulates migration data.

The communication resources 230 may be configured to facilitate the exchange of data between the apparatus 200 and the external computing environment. The communication resources 230 may include an input/output interface configured to sample performance counters. The processor 202 utilizes the communication resources 230 to read values from a kernel or a hardware performance monitoring unit. These values may include the raw counts of instructions, cache misses, and memory accesses that the processor 202 transforms into the feature parameters and performance metrics used in the graph. The communication resources 230 may also provide the pathway for transmitting the determined actions to the virtualization management stack.

Through the communication resources 230, the processor 202 receives the raw data required to build the graph and calculate the edge metrics. This includes accessing the performance monitoring unit counters mentioned in FIG. 1 (e.g., instructions retired, last level cache misses, remote memory hits). The communication resources 230 may also facilitate the transmission of the determined action. When the apparatus 200 concludes that a corrective action is necessary, the instruction is sent via the communication resources 230 to the mechanism responsible for resource scheduling (e.g., the VM kernel scheduler). The apparatus 200 may be physically integrated into the platform as a system-on-chip component or implemented as a software appliance running on a management core. When implemented as software, the processor 202 refers to the physical processor executing the code of the apparatus 200.

FIG. 3 illustrates an example diagrammatic representation of a graph topology transformation during a workload migration event in accordance with various aspects described herein. The figure depicts the state of the graph data structure, as maintained in the memory of the apparatus. The diagram is divided into a first graph portion 301 and a second graph portion 302, which represent the topological state of a first computing resource and a second computing resource, respectively.

The first graph portion 301 corresponds to the source node from which a workload is migrating. Within this portion, a plurality of nodes represent workloads that remain resident on the first computing resource, such as VM1, VM3, and VM4. The first node 311 described as the node representing the state of the workload before the migration is shown as a virtual Node. The first node 311 is instantiated by the processor at the location within the graph corresponding to the first computing resource. This node 311 serves as a historical representation of the state of the migrating workload (e.g., VM2) prior to its departure. The dashed lines surrounding the first node 311 indicate its virtual or transient nature, distinguishing it from the active workload nodes. The first node 311 may retain the connectivity patterns and feature parameters of the workload as they existed before the migration.

The second graph portion 302 corresponds to the destination node where the workload has been moved. This portion includes a second node 312, representing the current active instance of the migrating workload (e.g., VM2). The second node 312 is depicted with connections to other local workloads on the second computing resource, such as VM1, VM3, and VM4, reflecting the new resource contention and locality relationships formed after the move.

Connecting the two graph portions is an edge 313 (i.e. a virtual edge). The edge 313 is a directed link originating from the first node 311 in the first graph portion 301 and terminating at the second node 312 in the second graph portion 302. This edge 313 represents the performance metric associated with the migration, such as the residual dependency of the second node 312 on the memory resources of the first computing resource. The visual representation of the edge 313 crossing the boundary between the two graph portions signifies the cross-node coupling that the graph neural network analyzes. The apparatus may utilize this structure to propagate feature data from the first node 311 to the second node 312 via the edge 313 to enable the evaluation of the migration's efficiency and the detection of potential anomalies based on the strength and persistence of this connection, as described herein.

In an example, the computing system described herein may be characterized by a non-uniform memory access architecture. The processor 202 may be configured to manage a graph data structure where the plurality of nodes representing computing resources corresponds to specific NUMA nodes or processor dies within this architecture. The apparatus 200 may correspondingly distinguish between a physical socket, which acts as a physical package on a motherboard, and a logical NUMA node, which includes a set of execution cores and a specific range of local memory. The processor 202 may employ internal partitioning techniques, such as cub-NUMA clustering or cluster-on-die, effectively splitting a single physical socket into multiple NUMA nodes. The graph data structure in that example may model these hierarchical distinctions to capture the varying latency costs associated with intra-socket versus inter-socket communication. In an example, the graph data structure may include a respective graph for each individual NUMA node.

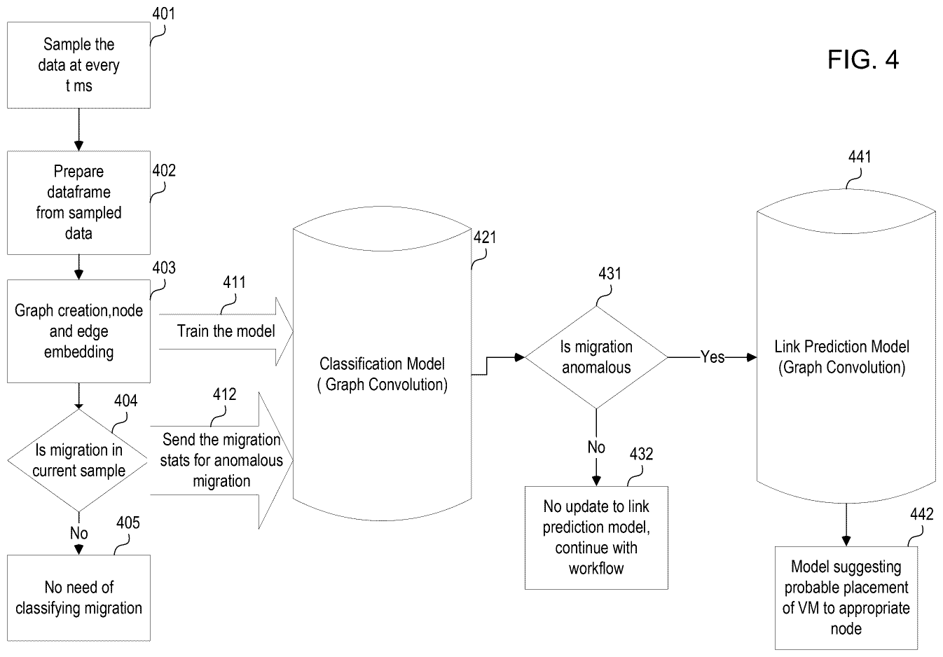

FIG. 4 shows an example flowchart of an operational process. The apparatus 200 may perform various functions to execute the process described herein. The process may begin with a processor (e.g. the processor 202) acquiring data from the computing environment to construct and update the graph data structure. This data acquisition phase is depicted in block 401, where the computing system samples data at a defined interval, denoted as t milliseconds. Following the sampling, the process moves to block 402, where the processor 202 prepares a dataframe from the sampled data. This dataframe serves as the structured input for the subsequent graph creation and embedding steps in block 403.

In an example, the processor 202 may update the graph data structure by sampling performance counters from a kernel or a performance monitoring unit of the computing environment. The processor 202 may continuously interface with the performance monitoring unit 163 or the hardware performance counters 106 described in FIG. 1 to retrieve real-time telemetry. The sampling process may involve the processor 202 reading specific registers dedicated to tracking architectural events, such as the number of instructions retired, the frequency of last-level cache misses, and the volume of memory controller transactions. The processor 202 may access these performance counters directly via hardware interfaces or indirectly through system calls provided by the virtual machine kernel 161.

The graph data structure may represent the model of the computing environment's hierarchy. In addition to the processor packages, dies, and cores, the processor 202 may identify and map modules and core building blocks as distinct nodes within the graph. The processor 202 may derive this detailed mapping from specific parameter sets, such as those provided by an Event Monitor (EMON) or similar performance monitoring tools.

In an example, the sampling interval t may be configurable, allowing the apparatus 200 to balance the granularity of the data against the computational overhead of the monitoring process. By sampling these counters, the processor 202 may determine a temporal snapshot of the system's resource utilization. The processor 202 may then process this raw data into the dataframe at block 402, where the processor 202 may normalize the counter values, calculate rates of change, or aggregate metrics across multiple cores to derive the feature parameters required for the node embeddings. The processor 202 monitoring hardware-level telemetry can cause the graph data structure to be maintained in the memory 204 reflecting the impact of workload behavior on the underlying resources within the physical computing environment.

The process proceeds to block 403, which involves graph creation, node embedding, and edge embedding. In block 403, the processor 202 may translate the sampled dataframe into the graph format. This phase may encompass both the initial construction of the graph and the iterative updates required during runtime. The graph format corresponds to the graph data structure that may represent a detailed hierarchy of the computing environment. The nodes within the graph may represent components at various levels of granularity, including processor packages, individual dies, or specific processing cores. By modeling the environment at the level of dies or cores, the processor 202 can detect contention issues that are masked when observing only socket-level metrics. For instance, the graph may capture that while a socket appears underutilized, a specific core or die within that socket is saturated.

In an example, the processor 202 may initialize the graph data structure upon a boot sequence of the computing system by mapping the hardware topology of the computing environment to the plurality of nodes representing computing resources. Upon the system bootup or the initialization of the monitoring service, the processor 202 may act as a front-end interface to discover the physical layout of the hardware platform. The processor 202 may interrogate the system firmware or the operating system to access configuration tables.

The processor 202 may utilize the data extracted from these tables to identify related information of the hardware resources, such as the number of non-uniform memory access nodes, the arrangement of processor sockets, and/or the specific interconnect links existing between them. Based on this topological mapping, the processor 202 may instantiate the initial set of nodes in the graph data structure, where each node corresponds to a distinct hardware resource, such as a NUMA node or a processor die. The processor 202 can further create edges between these resource nodes to represent the physical data paths. These edges may have weights according to the static bandwidth and latency characteristics defined in the system tables. In an example, the processor 202 may add each workload as a vertex to the corresponding graph of the respective computing node with its appropriate parameters. These vertices may be node embedded, and may be based on telemetry data, such as at least one or a combination of the total processing cycles allotted to the workload, the processing cycles utilized by the workload, and the number of memory pages allotted to the workload.

During the initialization phase, the processor 202 may generate distinct graph structures corresponding to each non-uniform memory access node discovered in the topology. Following this generation, the apparatus 200 may enter a standby mode. The apparatus 200 can remain in this standby state until the execution of a workload is detected, at which point it triggers the instantiation of the corresponding node within the specific graph structure associated with the NUMA node hosting the workload. This standby mechanism can facilitate that computational resources are not consumed for graph maintenance until active workloads are deployed on the platform.

Following the initialization and during the ongoing operation represented by block 403, the processor 202 may manage the representation of the workloads. The processor 202 may, prior to the migration, maintain an initial workload node representing the workload in the graph data structure connected to a first computing resource node representing the first computing resource. As workloads (virtual machines or containers) are provisioned and placed on the hardware, the processor 202 may detect these events and instantiate corresponding workload nodes in the graph data structure. The processor 202 connects each workload node to the specific resource node where the workload is currently executing, creating a distinct “residency” edge. This state, where the workload node is linked to its physical host, can constitute the initial pre-migration configuration. The processor 202 may continuously update the feature embeddings of this initial workload node using the data sampled in block 401. These features may include the workload's current memory footprint, cycle utilization, and cache behavior.

When a migration eventually occurs, the processor 202 may utilize the state of this initial workload node before the migration to instantiate the virtual node described in FIG. 3 and associate the corresponding virtual edge. The processor 202 may further, through its monitoring operations described herein, generate the destination workload node in the graph data structure, which represents the state of the migrated workload at the destination computing node.

At decision block 404, the processor 202 may determine whether a migration event is present in the current sample. If no migration is detected, the process moves to block 405, and no further classification is performed for that cycle. If a migration is detected, the process advances. The processor 202 may capture the migration statistics for the anomalous migration at block 412 and use them to train the model at block 411, updating the model parameters of the graph neural network. The core analysis occurs when the graph data structure, now modified to include the virtual node and virtual edge, is fed into the classification model at block 421.

In an example, the processor 202 may classify, as an action, the migration as anomalous based on one or more values of the performance metric. The processor 202 may implement the classification model represented by block 421 as a graph convolution network stored in the memory 204. The processor 202 executes this model to analyze the modified graph topology. The processor 202 may input the embeddings of the workload nodes, the resource nodes, and the weight of the virtual edge connecting the virtual node to the current workload node. This virtual edge weight represents the performance metric, such as the edge strength derived from remote memory accesses or cache coherency traffic. The processor 202 may evaluate this performance metric against learned patterns to determine if the migration state is stable or not.

At decision block 431, the processor 202 may determine if the migration is anomalous. The processor 202 may classify the migration as anomalous if the performance metric remains high for a specific duration, such as 2 to 3 time epochs, indicating that the workload has not successfully decoupled from its source node. If the processor 202 classifies the migration as non-anomalous (No), the process proceeds to block 432, where the processor 202 continues the workflow without updating the link prediction model.

If the processor 202 classifies the migration as anomalous (Yes) at block 431, the process may advance to block 441, where a link prediction model is triggered. The link prediction model, which may utilize a graph convolution architecture, may analyze the embeddings to calculate probability scores for connections between the anomalous workload and other potential resource nodes. Finally, at block 442, the processor 202 generates a model output suggesting a probable placement of the virtual machine to an appropriate node. The processor 202 may derive this suggestion from the link prediction scores and perform the corrective action of migrating to the appropriate node to resolve the detected anomaly.

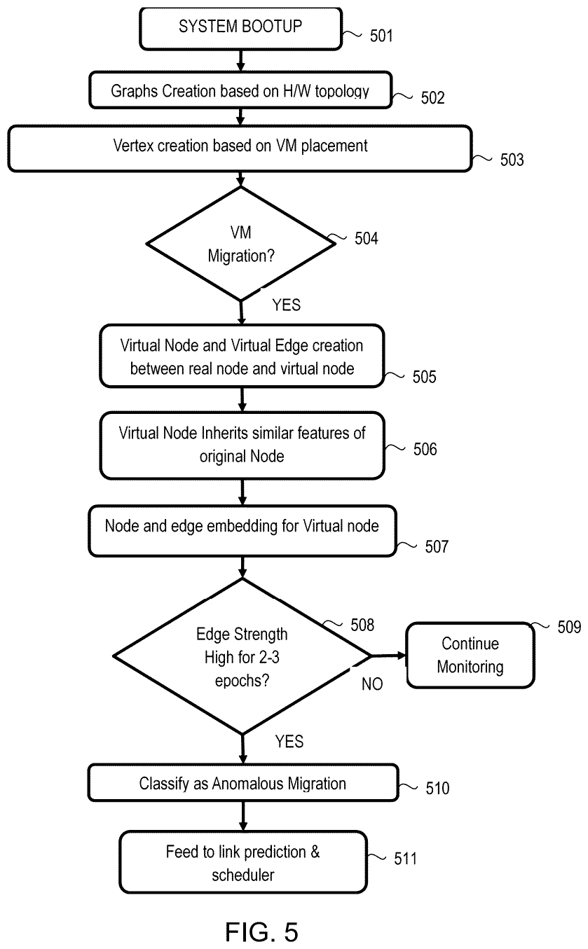

FIG. 5 shows an example flow diagram that may be executed by the apparatus 200, and specifically the processor 202, to perform various aspects described herein. The process can begin at block 501 with the system bootup, where the processor 202 may initialize the monitoring environment. At block 502, the processor 202 creates the initial graph data structures based on the discovered hardware topology, and at block 503, the processor may populate these graphs with vertices representing the initial placement of virtual machines. The logic proceeds to decision block 504, where the processor 202 continuously monitors the environment to detect a virtual machine migration event. If a migration is detected (“YES”), the processor 202 initiates techniques for virtual node creation, embedding, and analysis shown in blocks 505 through 511, as described herein. If there is no detection of migration, the processor 202 may continue of monitoring telemetry data and environment, unless a migration is detected.

In an example, the processor 202 may assign, to instantiate the first node, feature parameters to the first node that are identical to feature parameters associated with the workload at the first computing resource prior to the migration. This function corresponds to the logic depicted in block 506. In block 506, the processor 202 may cause the virtual node to inherit similar features of original Node.

When the processor 202 detects the migration at block 504, the processor 202 may perform a state preservation operation. The processor 202 may access the historical telemetry data associated with the workload node as it existed on the source (first) computing resource immediately before the migration trigger. The processor 202 may duplicate this specific data structure, effectively capturing a snapshot of the workload's resource consumption profile. The processor 202 may further map this frozen profile to the feature vector of the newly instantiated first node (virtual node). In an example, before deleting the actual node from the graph data structure with the migration trigger, which the actual node represents the state of the workload at the source computing resource, the processor 202 may generate a copy of the actual node.

By assigning identical feature parameters, the processor 202 ensures that the virtual node serves as a mathematically precise reference point. This may allow the subsequent graph neural network layers to calculate a differential or “delta” between the workload's historical behavior (represented by the virtual node) and its current behavior (represented by the active workload node).

In an example, the feature parameters associated with the workload at the first computing resource (the source computing node) include at least one of: allotted processing cycles, utilized processing cycles, or memory pages allotted to the workload. The processor 202 may select one or a combination of these specific metrics, in which a respective metric may represent an operation state or resource intensity of the workload. Allotted processing cycles may refer to the maximum processor time defined by the hypervisor's scheduler (e.g., a quota or limit), representing a designated ceiling of the workload's performance. Utilized processing cycles may refer to the actual processor time consumed, representing the active load. Memory pages allotted may refer to the resident set size or the total memory footprint of the virtual machine.

In addition to the feature parameters associated with the workloads, the processor 202 may utilize specific dynamic parameters for the embedding of the nodes representing the computing resources (e.g., the NUMA nodes). These resource-specific parameters may include the total processing cycles allotted to the node and the processing cycles actually utilized by the node. By embedding these node-level utilization metrics alongside the workload metrics, the graph neural network can capture the saturation state of the physical hardware itself.

Correspondingly, the processor may capture the discrepancy between allotted and utilized cycles, based on which the processor 202 can infer if the workload was throttled or efficient at the source. By capturing the memory page count, the processor 202 may establish the magnitude of data that must be transferred. The processor 202 embeds these scalars into the feature vector of the virtual node. This feature set may allow the graph neural network to weight the importance of the virtual node; a workload with a desired memory footprint and utilization, which may result in a virtual node with a stronger influence on the graph's embeddings than a small, idle workload.

In an example, processing the graph data structure using the graph neural network includes updating a latent embedding of the second node by aggregating feature parameters from the first node propagated via the edge representing the performance metric to capture a residual dependency of the workload on the first computing resource. In an example, in block 507, the processor 202 may arrange node and edge embeddings for the virtual node. The processor 202 may execute a message-passing algorithm, typical of graph convolutional networks. During this phase, the processor 202 computes the new embedding for the second node (the active workload at the destination) by gathering information from its neighbors. Because the processor 202 has connected the first node (virtual node) to the second node via a weighted edge, the first node may be treated as a neighbor. The processor 202 may multiply or scale the feature parameters of the first node (the historical state) by the weight of the edge (i.e. the migration friction) and aggregate multiplied or scaled parameters into the second node's representation. This mathematical operation can effectively include the history of the migration into the current state. If the edge weight is high, indicating high friction, the first node's features dominate the aggregation, signaling to the classification layer that the workload is still functionally dependent on the source. This aggregation mechanism can allow the processor 202 to capture the non-linear residual dependency.

The graph neural network may process the graph data structure using a message-passing rule to update the latent embeddings. For the second node representing the workload at the destination, the aggregation of features includes the contribution from the first node (the virtual node) modulated by the virtual edge. The processor 202 may update the embedding

$${h}_{i}^{( l + 1 )}$$

of the second node i at layer (1+1) according to the following propagation rule:

$${h}_{i}^{( l + 1 )} = σ ( {\sum }_{j ϵ N ( i )} {W}^{( l )} {h}_{j}^{( l )} + {W}_{virt} \cdot {h}_{virt}^{( l )} )$$

wherein N(i) represents the set of standard neighbors (e.g., other workloads on the same resource), W^{(l)} is a learnable weight matrix of the layer, σ is a non-linear activation function (e.g., ReLU),

$${h}_{virt}^{( l )}$$

is the feature vector of the first node (virtual node), and Wᵥᵢᵣₜ corresponds to the calculated performance metric of the virtual edge. By explicitly including the term Wᵥᵢᵣₜ.

$${h}_{virt}^{( l )} ,$$

the model forces the embedding of the current workload to mathematically depend on its pre-migration state proportional to the migration friction.

In an example, the processor 202 may calculate the performance metric represented by the edge based on a page migration rate of memory pages associated with the workload transferring from the first computing resource to the second computing resource. This calculation may occur as part of the logic leading into decision block 508. The processor 202 may query the memory controller or the hypervisor's migration daemon to determine the rate at which memory pages are being copied across the interconnect. This page migration rate may serve as a primary proxy for the physical progress of the migration. During the pre-copy or post-copy phases of a live migration, this rate fluctuates. A high rate can indicate that the workload is still in a transient state with significant data remaining at the source. The processor 202 maps this rate to the scalar weight of the virtual edge. By basing the performance metric on this physical transfer rate, the processor 202 can ensure that the graph topology reflects the actual hardware status in this context. As the migration nears completion and the rate drops to zero, the edge weight decreases, which may allow the graph neural network to naturally forget the virtual node as the workload settles.

The processor 202 may be configured to maintain the structural elements representing the migration history based on the status of memory transfer. In an example, the processor 202 retains the first node (virtual node) and the edge (virtual edge) within the graph data structure until a completion condition is satisfied. The completion condition may be defined as the state where all memory pages associated with the workload are completely migrated from the first computing resource to the second computing resource. Upon the confirmation that all pages are migrated, the processor 202 may remove the first node and the edge from the graph data structure, as the residual dependency modeled by these elements is no longer physically present.

The processor 202 may further determine the performance metric based on a monitoring of telemetry data representing one or more monitored states of the workload at the second computing resource. The processor 202 augments the transfer rate with observation of the workload's behavior at the destination. The monitored states may include the frequency of remote memory accesses (e.g., a processor core on Node 2 accessing RAM on Node 1) and the volume of cache coherency traffic (e.g., snoop requests). The processor 202 may continuously sample these telemetry points via the performance monitoring unit. If the workload at the second computing resource is generating a high volume of remote requests, the processor 202 may issue an indication that the migration has created a situation where compute and memory are separated. The processor 202 may incorporate these values into the edge strength calculation. This may allow that even if the page migration rate is low (e.g., migration is technically “finished”), the apparatus can still detect if the workload is suffering from high latency due to residual remote dependencies that were not effectively moved.

In an example, the performance metric may include a composite metric derived from hardware telemetry data, wherein the composite metric represents a residual coupling between a current execution state of the workload (i.e. the state of the workload operational at the second computing resource) and the first computing resource. The processor 202 may compute this composite metric to provide a single indicator of migration friction. For example, the processor 202 may implement a normalization function that combines the page migration rate and the remote access telemetry into a unified value between 0 and 1. This composite metric may be representative of the residual coupling, which may correspond to a metric indicator (e.g. degree) to which the workload is still tethered to the first computing resource. For instance, the processor 202 might weight the remote access latency higher than the bandwidth usage, reflecting the greater impact of latency on application performance. By deriving a composite metric, the processor 202 can simplify the input to the graph neural network.

For example, the processor 202 calculates the composite metric, denoted herein as the edge weight Wedge, utilizing a weighted normalization function based on the monitored telemetry. The processor 202 may compute the weight according to the following example equation:

$${W}_{edge} = α ( \frac{{r}_{mig}}{{R}_{max}} ) + β ( \frac{{t}_{c o h}}{{T}_{max}} )$$

wherein r_{mig} represents the current page migration rate, Rₘₐₓ represents the maximum theoretical bandwidth of the memory interconnect, t_{coh} represents the count of cache coherency transactions (e.g., snoop hits), and Tₘₐₓ represents a saturation threshold for the interconnect links. The coefficients α and β are weighting factors determined by the system context; for example, in latency-sensitive applications, the processor 202 may assign a higher value to β to penalize cache contention more heavily than memory bandwidth usage. This scalar W_{edge} is assigned as the attribute of the virtual edge connecting the first node (virtual node) to the second node.

In an example, the processor 202 may monitor the performance metric over a predetermined number of time epochs to determine if the performance metric decreases over time. For example, as depicted in decision block 508, the processor 202 may determine if the performance metric (i.e. the edge strength) is above a threshold for n number of epochs, n being an integer greater than 0 (e.g., 2 or 3 epochs). The processor 202 may store the calculated performance metric in a time-series buffer. The processor 202 may evaluate the slope or trend of this metric over the specified window (e.g., 2 to 3 epochs). In a normal scenario, the edge strength should decay as the operating system's background processes complete the memory transfer and the caches warm up. The processor 202 may identify this expected negative trend. Monitoring over time epochs may allow the apparatus to differentiate between the naturally high edge strength that occurs at the exact moment of migration (which is normal) and a high edge strength that persists (which is anomalous).

In an example, the processor may classify the migration as anomalous based on values of the performance metric over the predetermined number of time epochs. For example, if the monitoring in block 508 reveals that the performance metric remains elevated or fails to show the expected decay curve over the designated (e.g. 2-3 epoch) window, the processor 202 proceeds to the “YES” path. The processor 202 may identify the persistence of the high metric as evidence of a failure in the load balancing logic—for example, a ping-pong effect where the workload is bouncing between nodes, or a stalled migration where dirty pages are generated faster than they can be moved. The processor 202 may use the integrated value of the metric over time to drive the final classification decision, to facilitate that the system reacts only to sustained inefficiencies rather than transient spikes.

The processor 202 may classify the migration as anomalous if the performance metric fails to decay below a threshold within the predetermined number of time epochs. The processor 202 may dynamically adjust the threshold based on a system context of the computing environment. The processor 202 can calculate the threshold used in decision block 508 dynamically. The processor 202 may read a system context vector that may include global variables at least one or a combination of total platform utilization, interconnect saturation levels, and/or specific hardware capabilities (e.g., the presence of high-bandwidth memory). If the system context indicates that the platform is under heavy load, the processor 202 may increase the threshold, making the system less sensitive to anomalies to prevent excessive corrective migrations. Conversely, if the system is lightly loaded, the processor 202 may decrease the threshold to strictly enforce locality.

The processor 202 may further classify the migration as anomalous based on one or more values of the performance metric. For example, in block 510, once the conditions of block 508 are met (high metric over epochs), the processor 202 may flag the migration event. In an example, this classification triggers a state change, causing the processor 202 to operate in a remediation mode. The processor 202 may log this classification event, generating an alert for system administrators, and prepare the specific data structures required for the subsequent link prediction phase.

The processor may trigger a link prediction model of the graph neural network to identify a third computing resource for a further migration of the workload in response to classifying the migration as anomalous. For example, as depicted in block 511, the processor 202 may provide a feed to link prediction. The processor 202 may activate a distinct module of the graph neural network that is configured to perform a link prediction to identify a further computing resource. In an example, this distinct module may predict optimal future states. The processor 202 can task this model with finding a third computing resource, which is an alternative destination node, that resolves the friction identified by the anomaly. In some examples, this third computing resource might be the original source node (a revert) or a completely new node that was not involved in the initial migration. By triggering this specific model, the processor 202 can leverage the learned topological embeddings to make a proactive recommendation.

In an example, the link prediction model may be configured to identify the third computing resource by calculating a probability score representing a likelihood of a connection between the second node representing the workload and a third node representing the third computing resource. The processor 202 may perform a series of vector operations (e.g., dot products) between the embedding of the anomalous workload node and the embeddings of all other available resource nodes in the graph. The result of each operation may be a scalar probability score that represents the compatibility or affinity between the workload and the target resource. A high score indicates that the target node has the capacity, connectivity, and feature match (e.g., available cache) to host the workload efficiently. The processor 202 may rank these scores to identify the single best candidate for the third computing resource.

The processor may transmit a control signal, as described herein, to a hypervisor scheduler to initiate the further migration of the workload to the third computing resource based on the identified third computing resource. Following the identification in block 511, the processor 202 may execute the remediation. The processor 202 generates a control signal, which may be compliant with the hypervisor's management interface (e.g., a libvirt command or a kernel system call). This signal may carry the instruction to migrate the specific virtual machine (e.g. the previously migrated virtual machine) to the specific node (e.g. the third computing resource) identified by the link prediction model. By transmitting this signal, the processor 202 may directly influence the system's resource allocation to resolve the detected performance anomaly and restore system stability.

In an example, the processor 202 may train the graph neural network using a loss function that maximizes probabilities assigned to existing positive edges in the graph data structure while minimizing probabilities assigned to non-existent negative edges. For example, this training process underpins the accuracy of the decisions in blocks 510 and 511. The processor 202 may periodically execute a training routine, either online or offline. The processor 202 may utilize a binary cross-entropy loss function or a similar objective function. The processor 202 feeds the model with training data including information of positive examples (e.g. pairs of nodes that are successfully connected and performing well) and information of negative examples (e.g. pairs of nodes that are not connected or have poor performance connections). The optimization of this loss function adjusts the internal weights of the neural network, ensuring that the embeddings generated in block 507 accurately capture the structural affinities of the topology. This training ensures that when the link prediction model calculates a high probability score, it corresponds to a genuinely viable and efficient placement.

To generate the training dataset including the positive and negative examples, the processor 202 may utilize the historical time-series analysis described in relation to the threshold monitoring. The processor 202 may log migration events and monitors the subsequent decay of the performance metric (edge strength). If the edge strength of a specific migration event fails to decay below the threshold within the predetermined number of epochs, the processor 202 may label this historical event as a positive instance of an anomaly (e.g., Label=1). If the edge strength decays as expected, the processor 202 may label the event as a successful migration (e.g., Label=0). These historically generated labels can serve as the ground truth for the loss function optimization, allowing the graph neural network to learn the topological patterns that precede these outcomes.

The training of the link prediction model may involve a forward method that accepts a node feature matrix along with indices for positive edges (existing connections) and negative edges (non-existent connections). The processor 202 may process these inputs through an encode method to generate embeddings, which then branch into two distinct prediction paths. A first path calculates probability scores for the positive edges, while a second path calculates probability scores for the negative edges. The loss function may be computed by summing two distinct loss components derived from these paths: a first component that encourages high probabilities for positive edges and a second component that encourages low probabilities for negative edges. This summed loss approach can optimize the model's ability to distinguish between legitimate resource couplings and anomalous migration patterns.

The implementation of the techniques described herein may result in quantifiable performance improvements for workloads executing in the computing environment. Experimental data derived from standard benchmarks, such as SpecInt and SpecJBB, indicated that the utilization of the graph neural network with the virtual node analysis reduces performance degradation. In scenarios involving varying utilization levels (e.g., 75% to 100%), the apparatus 200 may achieve performance improvements in the range of approximately 7% to 10% compared to systems utilizing standard schedulers without the graph-based anomaly detection. For example, in a SpecJBB benchmark test, a performance improvement of approximately 9.90% was observed at 100% utilization.

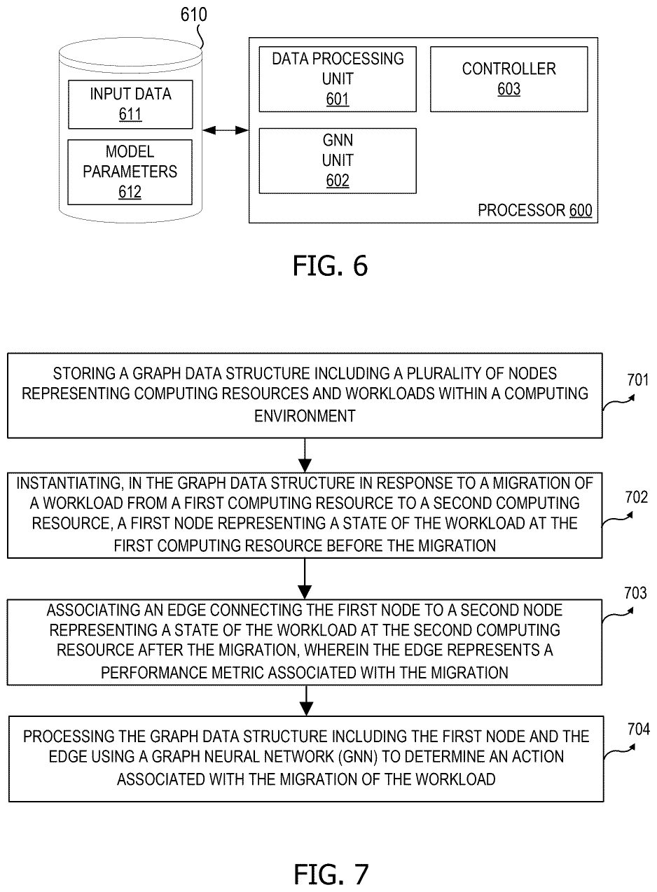

FIG. 6 shows schematically an example of a processor and a memory to implement a graph neural network (GNN) in accordance with various aspects provided herein. The processor 600 is depicted to include various functional units that are configured to provide various functions as disclosed herein, associated with the processor 202 or the one or more processors 102. The skilled person would recognize that the depicted functional units are provided to explain various operations that the processor 600 may be configured to perform. Similarly, the memory 610 (e.g. the memory 402) is depicted to include the input data 611 as a block, however, the memory 610 may store the input data 611 in any kind of suitable configuration or mechanism.

The “input data” may refer to or may include the data to be inputted to the GNN model in accordance to aspects described herein. In various examples, the input data may include a graph as described herein, which includes a two dimensional representation of nodes, edges, node embeddings, as described herein. In this scenario, the “output data” may refer to any parameter that the processor 202 uses to determine the action. In the context of anomaly detection, the output data may include an indication whether the migration is anomalous. In the context of link prediction, the output data may include an indication of a computing resource (e.g. the third computing resource) within the computing system 100.

Furthermore, the GNN unit 602 is depicted as it is implemented in the processor 600 only as an example, and any type of GNN implementation which may include the implementation of the GNN model in an external processor, such as an accelerator, a graphics processing unit (GPU), a neuromorphic chip, or in a cloud computing device, or in an external processing device may also be possible according to any methods.

The processor 600 may include a data processing unit 601 that is configured to process data and obtain input of the GNN unit based on the input data 611 as provided in various examples in this disclosure to be stored in the memory 610. In various examples, the input data 611 may include data of not only current but also past information for at least within a period of time in a plurality of instances of time (e.g. as a time-series data).

The data processing unit 601 may implement various preprocessing operations to obtain the input. Such operations may include cleaning the input data 611 by removing outliers, handling of missing parameters, correcting errors or inconsistencies, and such. Operations may further include data normalizations in order to scale the input data 611 to a common range. Operations may further include data transformation including mapping the input data 611 based on predefined mapping operations corresponding to mathematical functions to map one or more data items of the input data 611 to a mapped data time for the purpose of analysis. Illustratively, the data processing unit 601 may act as a front end for processing of the graph data structure.

The data processing unit 601 may be configured to generate training dataset based on the input data 611. In other words, based output of the GNN unit 602 in response to the input of the GNN model, the data processing unit 601 may prepare the training data to be used in the training of the GNN model. The data processing unit 601 may be configured to apply data fusion techniques to aggregate data. Data fusion may be considered as a process of integrating and combining data, within this context, by combining the input data 611 to obtain a unified dataset.

The data processing unit 601 may further implement feature extraction operations. It is to be considered that the GNN model implemented by the GNN unit 602 may have certain constraints, some of which may relate to the structure and aspects of the data to be inputted to the GNN. The feature extraction operations may include translating (i.e. transforming) the input data 611 into input of the GNN model. The feature extraction operations may further include generation of training input data for the training dataset based on the input data 611. In some aspects, the feature extraction operations may be based on model information representing the attributes to be used as the input of the GNN model, relative importance or weights of the attributes, etc. The feature extraction operations may include reducing the number of attributes (i.e. data items from the input data 611) to be used, ranking of the attributes, etc. based on the model information.

In some aspects, the input data 611 may include information representative of annotations and/or labels to be used for training. In some aspects, the data processing unit 601 may also assign labels or assign ground truth values for the generated training data for the generation of the training dataset. In some aspects, the data processing unit 601 may further generate annotations for the generation of the training data set. Generation of annotations and/or labels may be according to supervised training inputs, or may be based on unsupervised methods, exemplarily by an implementation of an automatized model to assign the labels and/or the annotations.

It is to be noted that the GNN unit 602 may use the training dataset in predefined portions, namely a first portion of the training data set for training, a second portion of the training dataset for validation and a third portion of the training dataset for testing purposes. The GNN unit 602 may use the first portion to train the GNN model, which may allow the GNN to learn the underlying patterns and relationships in the data. The GNN unit 602 may use the second portion to evaluate and fine-tune the GNN model during the training process, which may help to prevent overfitting and improve generalization. Finally, the GNN unit 602 may use the third portion to assess the performance of the trained GNN model and provide an unbiased estimate of their accuracy and effectiveness for GNN model tasks.

The GNN unit 602 may implement one or more GNN models. As described herein, the GNN unit 602 may include a GNN model for migration anomaly detection and a further GNN model for link prediction. The GNN model may be configured to receive the input with certain constraints, features, and formats. Accordingly, the data processing unit 601 may obtain the input of the GNN, that is based on the input data 611, to be provided to the GNN model to obtain an output of the GNN model. In various examples, the data processing unit 601 may provide input data including the input data 611 to the GNN model. The input of the GNN may model include attributes of the input data 611 associated with a period of time or a plurality of consecutive periods of time. In various examples, the data processing unit 601 may convert the input data 611 to an input format suitable for the GNN model (i.e. feature extraction e.g. to input feature vectors) so that the GNN model may process the input data 611. It is to be noted that the input of the GNN model may naturally include data, though the term input of the GNN has been used to distinguish from the term “input data”.

The processor 600 may further include a controller 603 to control the GNN unit 602. The controller 603 may provide the input to the GNN model, or provide the GNN unit 602 instructions to obtain the output. The controller 603 may further be configured to perform further operations of the processor 600 in accordance with various aspects of this disclosure.

The GNN model may be any type of machine learning model configured to receive the input of the GNN model and provide an output as provided in this disclosure. The GNN model may stand for the ML-based application provided in the disclosure. The GNN model may include a neural network. The neural network may be any type of artificial neural network. The neural network may include any number of layers, including an input layer to receive the input of the GNN model, an output layer to provide the output data. A number of layers may be provided between the input layer and the output layer (e.g. hidden layers). The training of the neural network (e.g., adapting the layers of the neural network, adjusting model parameters 612) may use or may be based on any kind of training principle, such as backpropagation (e.g., using the backpropagation algorithm).

For example, the neural network may be a feed-forward neural network in which the information is transferred from lower layers of the neural network close to the input to higher layers of the neural network close to the output. Each layer may include neurons that receive input from a previous layer and provide an output to a next layer based on certain GNN model (e.g. weights) parameters 612 adjusting the input information. In various examples, the neural network may be configured in top-down configuration in which a neuron of a layer provides output to a neuron of a lower layer, which may help to discriminate certain features of an input.

The GNN model may include a recurrent neural network in which neurons transfer the information in a configuration in which the neurons may transfer the input information to a neuron of the same layer. Recurrent neural networks (RNNs) may help to identify patterns between a plurality of input sequences, and accordingly, RNNs may be used to identify, in particular, a temporal pattern provided with time-series data and perform estimations based on the identified temporal patterns. In various examples of RNNs, long short-term memory (LSTM) architecture may be implemented. The LSTM networks may be helpful to perform classifications, processing, and estimations using time series data.

An LSTM network may include a network of LSTM cells that may process the attributes provided for an instance of time as input of the GNN model, such as attributes provided for the instance of time, and one or more previous outputs of the LSTM that have taken in place in previous instances of time, and accordingly, obtain the output data. The number of the one or more previous inputs may be defined by a window size, and the weights associated with each previous input may be configured separately. The window size may be arranged according to the processing, memory, and time constraints and the input of the GNN model. The LSTM network may process the features of the received raw data and determine a label for an attribute for each instance of time according to the features. The output data may include or represent a label associated with the input of the GNN model.

In accordance with various aspects, the GNN model may include a reinforcement learning model. The reinforcement learning model may be modeled as a Markov decision process (MDP). The MDP may determine an action from an action set based on a previous observation which may be referred to as a state. In a next state, the MDP may determine a reward based on the current state that may be based on current observations and the previous observations associated with previous state. The determined action may influence the probability of the MDP to move into the next state. Accordingly, the MDP may obtain a function that maps the current state to an action to be determined with the purpose of maximizing the rewards. Accordingly, input of the GNN model for a reinforcement learning model may include information representing a state, and an output data may include information representing an action.

Reinforcement learning (RL) is a type of machine learning that focuses on training an agent to make decisions by interacting with an environment. The agent learns to perform actions to achieve a goal by receiving feedback in the form of rewards or penalties. As a machine learning model, reinforcement learning models learn from data (in this case, the agent's experiences and interactions with the environment) to adapt their behavior and improve their performance over time. Since machine learning is a subset of AI, reinforcement learning models are also considered AI models, as they aim to perform tasks that require human-like decision-making capabilities.

The GNN model may include a convolutional neural network (CNN), which is an example for feed-forward neural networks that may be used for the purpose of this disclosure, in which one or more of the hidden layers of the neural network include one or more convolutional layers that perform convolutions for their received input from a lower layer. The CNNs may be helpful for pattern recognition and classification operations. The CNN may further include pooling layers, fully connected layers, and normalization layers.

The GNN model may include a generative neural network. The generative neural network may process input of the GNN model in order to generate new sets, hence the output data may include new sets of data according to the purpose of the GNN model. In various examples, the GNN model may include a generative adversarial network (GAN) model in which a discrimination function is included with the generation function, and while the generation function may generate the data according to model parameters 612 of the generation function and the input of the GNN model, the discrimination function may distinguish the data generated by the generation function in terms of data distribution according to model parameters 612 of the discrimination function

The GNN model may include a trained GNN model (e.g. the model parameters 612 in a memory are already set for the purpose) that is configured to provide the output as provided in various examples in this disclosure based on the input of the GNN model and one or more model parameters 612. The trained GNN model may be obtained via an online and/or offline training. A training agent may perform various operations with respect to the training at various aspects, including online training, offline training, and optimizations based on the inference results. The GNN model may take any suitable form or utilize any suitable technique for training process. For example, the GNN model may be trained using supervised learning, semi-supervised learning, unsupervised learning, or reinforcement learning techniques.

For supervised learning, generation of labels and annotations may require domain expertise and an understanding of the specific tasks that the GNN is designed to address. For example, a human expert might need to review logs and performance data, which could then be labeled as positive or negative examples for a migration anomaly detection model or a link prediction model. In some cases, semi-supervised or unsupervised learning techniques can be used to reduce the reliance on labeled data. These approaches may involve clustering, anomaly detection, or other methods that can identify patterns and relationships in the data without explicit ground truth labels.

In supervised learning, the GNN model may be obtained using a training dataset including both inputs and corresponding desired outputs (illustratively, input data may be associated with a desired or expected output for that input data). Each training instance may include one or more input data item and a desired output. The training agent may train the GNN model based on iterations through training instances and using an objective function to teach the GNN model to estimate the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training dataset including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive feedback (also referred to as reward) or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

The training agent may adjust the model parameters 612 of the respective model based on outputs and inputs (i.e. output data and input data). The training agent may train the GNN model according to the desired outcome. The training agent may provide the training data to the GNN model. In various examples, the processor 600 and/or the GNN unit 602 itself may include the training agent, or another entity that may be communicatively coupled to the processor may include the training agent and provide the training data to the device, so that the processor may train the GNN model.

The GNN model may include an execution unit and a training unit that may implement the training agent as provided in this disclosure for other examples. In accordance with various examples, the training agent may train the GNN model based on a simulated environment that is controlled by the training agent according to similar considerations and constraints of the deployment environment.

The skilled person would immediately recognize that the exemplary GNN model disclosed herein is explained that may have many configurations. In an example scenario, for execution of the GNN model (i.e. inference), the GNN may be configured to provide an output as described in the examples of the output data. For training of the GNN model, the training agent may train the GNN model by providing training input data of the generated training dataset to the input of the GNN. The training agent may adjust model parameters 612 of the GNN model based on the output of the GNN model that is mapped according to the training input data, and training output data of the training dataset (e.g. labels, annotations) associated with the provided training input data with an intention to make the output of the GNN more accurate. In this constellation, the training input data may include predefined or predetermined data representing examples provided for the input data in different configuration and/or scenarios (e.g. generated with simulations, generated based on past records) and the training output data may include corresponding predefined or predetermined data representing examples provided for the output data, each corresponding to a respective training input data.

Accordingly, the training agent may adjust one or more model parameters 612 based on a calculation including parameters for the output of the GNN model for the training input data and the training output data associated with the training input data. In various examples, the calculation may also include one or more parameters of the GNN model. With each iteration with respect to the training input data that may include many data items, which each data item may represent an input of an instance (of time, of observation, etc.) on various aspects and each iteration may iterate a respective data item representing an input of an instance, the training agent may accordingly cause the GNN to provide more accurate output through adjustments made in the model parameters 612.

The processor 600 may implement the training agent, or another entity that may be communicatively coupled to the processor 600 may include the training agent and provide the training input data to the device, so that the processor 600 may train the GNN model. The training agent may be part of the GNN unit 602 described herein. Furthermore, the controller 603 may control the GNN unit 602 according to a predefined event. For example, the controller 603 may provide instructions to the GNN unit 602 to perform the inference and/or training in response to a received request from another entity. The controller 603 may further obtain output of the GNN model from the GNN unit 602.

FIG. 7 shows an example of a method. The method may include storing 701 a graph data structure comprising a plurality of nodes representing computing resources and workloads within a computing environment; instantiating 702, in the graph data structure in response to a migration of a workload from a first computing resource to a second computing resource, a first node representing a state of the workload at the first computing resource before the migration; associating 703 an edge connecting the first node to a second node representing a state of the workload at the second computing resource after the migration, wherein the edge represents a performance metric associated with the migration; and processing 704 the graph data structure comprising the first node and the edge using a Graph Neural Network (GNN) to determine an action associated with the migration of the workload.

The detailed description refers to the accompanying drawings that show, by way of illustration, specific details and aspects of this disclosure in which the disclosure may be practiced. Other aspects may be utilized and structural, logical, and electrical changes may be made without departing from the scope of the disclosure. The various aspects of this disclosure are not necessarily mutually exclusive, as some aspects of this disclosure can be combined with one or more other aspects of this disclosure to form new aspects.

Throughout the drawings, it should be noted that like reference numbers are used to depict the same or similar elements, features, and structures, unless otherwise noted.

The word “exemplary” is used herein to mean “serving as an example, instance, or illustration”. Any aspect or design described herein as “exemplary” is not necessarily to be construed as preferred or advantageous over other aspects or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, unless otherwise specified the use of the ordinal adjectives “first”,

“second”, “third” etc., to describe a common object, merely indicate that different instances of like objects are being referred to, and are not intended to imply that the objects so described must be in a given sequence, either temporally, spatially, in ranking, or in any other manner.

As utilized herein, terms “module”, “component,” “system,” “circuit,” “element,” “slice,” “circuitry,” and the like are intended to refer to a set of one or more electronic components, a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuits can reside within the same circuitry, and circuitry can be localized on one computer and/or distributed between two or more computers. A set of elements or a set of other circuits can be described herein, in which the term “set” can be interpreted as “one or more.”

It will be understood that when an element is referred to as being “connected” or “coupled” to another element, it can be physically connected or coupled to the other element such that current and/or electromagnetic radiation (e.g., a signal) can flow along a conductive path formed by the elements. Intervening conductive, inductive, or capacitive elements may be present between the element and the other element when the elements are described as being coupled or connected to one another. Further, when coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

The following examples pertain to further aspects of this disclosure.

Example 1 includes the subject matter of an apparatus including: a memory configured to store a graph data structure including a plurality of nodes representing computing resources and workloads within a computing environment; and a processor configured to: instantiate, in the graph data structure in response to a migration of a workload from a first computing resource to a second computing resource, a first node representing a state of the workload at the first computing resource before the migration; associate an edge connecting the first node to a second node representing a state of the workload at the second computing resource after the migration, wherein the edge represents a performance metric associated with the migration; and process the graph data structure including the first node and the edge using a Graph Neural Network (GNN) to determine an action associated with the migration of the workload.

Example 2 may include the subject matter of example 1, wherein the computing environment includes a Non-Uniform Memory Access (NUMA) architecture, and wherein the plurality of nodes representing computing resources correspond to NUMA nodes or dies within the NUMA architecture.

Example 3 may include the subject matter of example 1 or 2, wherein the processor is further configured to initialize the graph data structure upon a boot sequence of the computing environment by mapping a hardware topology of the computing environment to the plurality of nodes representing computing resources.

Example 4 may include the subject matter of any one of examples 1 to 3, wherein the processor is further configured to, prior to the migration, maintain an initial workload node representing the workload in the graph data structure connected to a first computing resource node representing the first computing resource.

Example 5 may include the subject matter of any one of examples 1 to 4, wherein the processor is further configured to assign, to instantiate the first node, feature parameters to the first node that are identical to feature parameters associated with the workload at the first computing resource prior to the migration.

Example 6 may include the subject matter of example 5, wherein the feature parameters associated with the workload at the first computing resource include at least one of: allotted processing cycles, utilized processing cycles, or memory pages allotted to the workload.

Example 7 may include the subject matter of any one of examples 1 to 6, wherein the performance metric represented by the edge is calculated based on a page migration rate of memory pages associated with the workload transferring from the first computing resource to the second computing resource.

Example 8 may include the subject matter of any one of examples 1 to 7, wherein the processor is further configured to determine the performance metric based on a monitoring of telemetry data representing one or more monitored states of the workload at the second computing resource.

Example 9 may include the subject matter of any one of examples 1 to 8, wherein the processor is further configured to classify, to determine the action, the migration as anomalous based on one or more values of the performance metric.

Example 10 may include the subject matter of example 9, wherein the processor is further configured to monitor the performance metric over a predetermined number of time epochs to determine if the performance metric decreases over time.

Example 11 may include the subject matter of example 10, wherein the processor is further configured to classify, to determine the action, the migration as anomalous based on values of the performance metric over the predetermined number of time epochs.

Example 12 may include the subject matter of example 11, wherein the processor is further configured to classify the migration as anomalous if the performance metric fails to decay below a threshold within the predetermined number of time epochs, and wherein the processor is configured to dynamically adjust the threshold based on a system context of the computing environment.

Example 13 may include the subject matter of example 11, wherein the processor is further configured to trigger a link prediction model of the GNN to identify a third computing resource for a further migration of the workload in response to classifying the migration as anomalous.

Example 14 may include the subject matter of example 13, wherein the link prediction model is configured to identify the third computing resource by calculating a probability score representing a likelihood of a connection between the second node representing the workload and a third node representing the third computing resource.

Example 15 may include the subject matter of example 13 or 14, wherein the processor is further configured to transmit a control signal to a hypervisor scheduler to initiate the further migration of the workload to the third computing resource based on the identified third computing resource.

Example 16 may include the subject matter of any one of examples 1 to 15, wherein processing the graph data structure using the GNN includes updating a latent embedding of the second node by aggregating feature parameters from the first node propagated via the edge representing the performance metric to capture a residual dependency of the workload on the first computing resource.

Example 17 may include the subject matter of any one of examples 1 to 16, wherein the processor is configured to train the GNN using a loss function that maximizes probabilities assigned to existing positive edges in the graph data structure while minimizing probabilities assigned to non-existent negative edges.

Example 18 may include the subject matter of any one of examples 1 to 17, wherein the processor is configured to update the graph data structure by sampling performance counters from a kernel or a performance monitoring unit (PMU) of the computing environment.

Example 19 may include the subject matter of any one of examples 1 to 18, wherein the graph data structure represents a hierarchy of the computing environment including nodes representing at least one of packages, dies, or cores.

Example 20 may include the subject matter of any one of examples 1 to 19, wherein the processor is further configured to generate a control signal based on the determined action, wherein the control signal includes an indication of a migration anomaly or an instruction for a further migration of the workload.

Example 21 may include the subject matter of any one of examples 1 to 20, wherein the performance metric includes a composite metric derived from hardware telemetry data, wherein the composite metric quantifies a residual coupling between a current execution state of the workload and the first computing resource.

Example 22 may include the subject matter of a method including: storing a graph data structure including a plurality of nodes representing computing resources and workloads within a computing environment; instantiating, in the graph data structure in response to a migration of a workload from a first computing resource to a second computing resource, a first node representing a state of the workload at the first computing resource before the migration; associating an edge connecting the first node to a second node representing a state of the workload at the second computing resource after the migration, wherein the edge represents a performance metric associated with the migration; and processing the graph data structure including the first node and the edge using a Graph Neural Network (GNN) to determine an action associated with the migration of the workload.

Example 23 may include the subject matter of example 22, wherein the computing environment includes a Non-Uniform Memory Access (NUMA) architecture, and wherein the plurality of nodes representing computing resources correspond to NUMA nodes or dies within the NUMA architecture.

Example 24 may include the subject matter of example 22 or 23, may further include initializing the graph data structure upon a boot sequence of the computing environment by mapping a hardware topology of the computing environment to the plurality of nodes representing computing resources.

Example 25 may include the subject matter of any one of examples 22 to 24, may further include, prior to the migration, maintaining an initial workload node representing the workload in the graph data structure connected to a first computing resource node representing the first computing resource.

Example 26 may include the subject matter of any one of examples 22 to 25, may further include assigning, to instantiate the first node, feature parameters to the first node that are identical to feature parameters associated with the workload at the first computing resource prior to the migration.

Example 27 may include the subject matter of example 26, wherein the feature parameters associated with the workload at the first computing resource include at least one of: allotted processing cycles, utilized processing cycles, or memory pages allotted to the workload.

Example 28 may include the subject matter of any one of examples 22 to 27, wherein the performance metric represented by the edge is calculated based on a page migration rate of memory pages associated with the workload transferring from the first computing resource to the second computing resource.

Example 29 may include the subject matter of any one of examples 22 to 28, wherein the processor is further configured to determine the performance metric based on a monitoring of telemetry data representing one or more monitored states of the workload at the second computing resource.

Example 30 may include the subject matter of any one of examples 1 to 8, may further include classifying, to determine the action, the migration as anomalous based on one or more values of the performance metric.

Example 31 may include the subject matter of example 30, may further include monitoring the performance metric over a predetermined number of time epochs to determine if the performance metric decreases over time.

Example 32 may include the subject matter of example 31, may further include classifying, to determine the action, the migration as anomalous based on values of the performance metric over the predetermined number of time epochs.

Example 33 may include the subject matter of example 32, may further include classifying the migration as anomalous if the performance metric fails to decay below a threshold within the predetermined number of time epochs, and wherein the processor is configured to dynamically adjust the threshold based on a system context of the computing environment.

Example 34 may include the subject matter of example 32, may further include triggering a link prediction model of the GNN to identify a third computing resource for a further migration of the workload in response to classifying the migration as anomalous.

Example 35 may include the subject matter of example 34, wherein the link prediction model is configured to identify the third computing resource by calculating a probability score representing a likelihood of a connection between the second node representing the workload and a third node representing the third computing resource.

Example 36 may include the subject matter of example 34 or 35, may further include transmitting a control signal to a hypervisor scheduler to initiate the further migration of the workload to the third computing resource based on the identified third computing resource.

Example 37 may include the subject matter of any one of examples 22 to 36, wherein processing the graph data structure using the GNN includes updating a latent embedding of the second node by aggregating feature parameters from the first node propagated via the edge representing the performance metric to capture a residual dependency of the workload on the first computing resource.

Example 38 may include the subject matter of any one of examples 22 to 37, may further include training the GNN using a loss function that maximizes probabilities assigned to existing positive edges in the graph data structure while minimizing probabilities assigned to non-existent negative edges.

Example 39 may include the subject matter of any one of examples 22 to 38, may further include updating the graph data structure by sampling performance counters from a kernel or a performance monitoring unit (PMU) of the computing environment.

Example 40 may include the subject matter of any one of examples 22 to 39, wherein the graph data structure represents a hierarchy of the computing environment including nodes representing at least one of packages, dies, or cores.

Example 41 may include the subject matter of any one of examples 22 to 40, may further include generating a control signal based on the determined action, wherein the control signal includes an indication of a migration anomaly or an instruction for a further migration of the workload.

Example 42 may include the subject matter of any one of examples 22 to 41, wherein the performance metric includes a composite metric derived from hardware telemetry data, wherein the composite metric quantifies a residual coupling between a current execution state of the workload and the first computing resource.

Example 43 may include a non-transitory computer-readable medium including instructions which, if executed by a processor, cause the processor to perform the method of any one of examples 22 to 42.

Example 44 may include an apparatus including means to perform the method of any one of examples 22 to 42.

What is claimed is:

1. An apparatus comprising:
a memory configured to store a graph data structure comprising a plurality of nodes representing computing resources and workloads within a computing environment; and
a processor configured to:
instantiate, in the graph data structure in response to a migration of a workload from a first computing resource to a second computing resource, a first node representing a state of the workload at the first computing resource before the migration;
associate an edge connecting the first node to a second node representing a state of the workload at the second computing resource after the migration, wherein the edge represents a performance metric associated with the migration; and
process the graph data structure comprising the first node and the edge using a Graph Neural Network (GNN) to determine an action associated with the migration of the workload.

2. The apparatus of claim 1, wherein the computing environment comprises a Non-Uniform Memory Access (NUMA) architecture, and wherein the plurality of nodes representing computing resources correspond to NUMA nodes or dies within the NUMA architecture.

3. The apparatus of claim 1, wherein the processor is further configured to initialize the graph data structure upon a boot sequence of the computing environment by mapping a hardware topology of the computing environment to the plurality of nodes representing computing resources.

4. The apparatus of claim 1, wherein the processor is further configured to, prior to the migration, maintain an initial workload node representing the workload in the graph data structure connected to a first computing resource node representing the first computing resource.

5. The apparatus of claim 1, wherein the processor is further configured to assign, to instantiate the first node, feature parameters to the first node that are identical to feature parameters associated with the workload at the first computing resource prior to the migration.

6. The apparatus of claim 5, wherein the feature parameters associated with the workload at the first computing resource comprise at least one of: allotted processing cycles, utilized processing cycles, or memory pages allotted to the workload.

7. The apparatus of claim 1, wherein the performance metric represented by the edge is calculated based on a page migration rate of memory pages associated with the workload transferring from the first computing resource to the second computing resource.

8. The apparatus of claim 1, wherein the processor is further configured to classify, to determine the action, the migration as anomalous based on one or more values of the performance metric.

9. The apparatus of claim 8, wherein the processor is further configured to monitor the performance metric over a predetermined number of time epochs to determine if the performance metric decreases over time.

10. The apparatus of claim 9, wherein the processor is further configured to classify, to determine the action, the migration as anomalous based on values of the performance metric over the predetermined number of time epochs.

11. The apparatus of claim 10, wherein the processor is further configured to classify the migration as anomalous if the performance metric fails to decay below a threshold within the predetermined number of time epochs, and wherein the processor is configured to dynamically adjust the threshold based on a system context of the computing environment.

12. The apparatus of claim 9, wherein the processor is further configured to trigger a link prediction model of the GNN to identify a third computing resource for a further migration of the workload in response to classifying the migration as anomalous.

13. The apparatus of claim 12, wherein the link prediction model is configured to identify the third computing resource by calculating a probability score representing a likelihood of a connection between the second node representing the workload and a third node representing the third computing resource.

14. The apparatus of claim 1, wherein the processor is configured to update the graph data structure by sampling performance counters from a kernel or a performance monitoring unit (PMU) of the computing environment.

15. The apparatus of claim 1, wherein the graph data structure represents a hierarchy of the computing environment including nodes representing at least one of packages, dies, or cores.

16. The apparatus of claim 1, wherein processing the graph data structure using the GNN comprises updating a latent embedding of the second node by aggregating feature parameters from the first node propagated via the edge representing the performance metric to capture a residual dependency of the workload on the first computing resource.

17. The apparatus of claim 1, wherein the processor is configured to update the graph data structure by sampling performance counters from a kernel or a performance monitoring unit (PMU) of the computing environment.

18. The apparatus of claim 1, wherein the processor is further configured to generate a control signal based on the determined action, wherein the control signal comprises an indication of a migration anomaly or an instruction for a further migration of the workload.

19. A non-transitory computer-readable medium comprising instructions which, if executed by a processor, cause the processor to:
instantiate, in graph data structure in response to a migration of a workload from a first computing resource to a second computing resource, a first node representing a state of the workload at the first computing resource before the migration, wherein the graph data structure comprising a plurality of nodes representing computing resources and workloads within a computing environment;
associate an edge connecting the first node to a second node representing a state of the workload at the second computing resource after the migration, wherein the edge represents a performance metric associated with the migration; and
process the graph data structure comprising the first node and the edge using a Graph Neural Network (GNN) to determine an action associated with the migration of the workload.

20. The non-transitory computer-readable medium of claim 19, wherein the performance metric comprises a composite metric derived from hardware telemetry data, wherein the composite metric quantifies a residual coupling between a current execution state of the workload and the first computing resource.
